(19) United States
(12) Patent Application Publication
(10) Pub. No.: US 2011/0196727 A1
(43) Pub. Date: Aug. 11, 2011

(54) Online Time Interval Based Sale Management Platform

(76) Inventors: Vikram Kothandaraman, Montebello, CA (US); Sara Ambrocio, Montebeloo, CA (US)

(21) Appl. No.: 13/024,485

(22) Filed: Feb. 10, 2011

Related U.S. Application Data
(60) Provisional application No. 61/303,340, filed on Feb. 11, 2010.

(51) Int. Cl. G06Q 30/00

(52) U.S. Cl. 705/14.23

(57) ABSTRACT

A computer implemented method and system is provided for facilitating a time interval based sale of sale items in an online environment. A sale management platform acquires sale items and sale information from merchandisers and consumers. The sale management platform determines an optimal time interval based on predetermined time criteria and determines optimal discount prices for the sale items based on the sale discount prices offered by the merchandisers, the acquired sale information, and predetermined price criteria. The sale management platform manages a fixed price sale or a bargain sale of selected sale items at one or more of the sale discount prices offered by the merchandisers and the optimal discount prices during the merchandiser-selected time interval, the consumer-selected time interval, or the optimal time interval. The sale management platform manages bargaining sessions between the merchandisers and the consumers until expiration of the time interval or acceptance of an offer.

### CROSS REFERENCE TO RELATED APPLICATIONS

This application claims the benefit of provisional patent application No. 61/303,340 titled “Online Time Interval Based Sale Management Platform”, filed on Feb. 11, 2010 in the United States Patent and Trademark Office.

The specification of the above referenced patent application is incorporated herein by reference in its entirety.

### BACKGROUND

The computer implemented method and system disclosed herein, in general, relates to an electronic sale management platform. More particularly, the computer implemented method and system disclosed herein relates to providing items for sale at discounted prices for predetermined time intervals, and conducting and managing online bargaining during predetermined time intervals on a sale management platform.

The trend of using electronic systems such as the Internet and other computer networks for purchasing and selling products and/or services, typically referred to as electronic commerce, has grown substantially with widespread Internet usage. The popularity of electronic commerce is due to the convenience that it offers consumers. Consumers can now shop at their convenience in their home, save time spent on not having to travel to retail stores, and minimize the overall shopping effort. Consumer traffic at commercial websites can vary substantially depending on the time of day and seasonal factors. For example, an electronic commerce website may see substantially increased consumer traffic in the period immediately preceding holiday seasons, special holidays, etc. In order to encourage consumers to purchase sale items at different times, there is a need for providing discounted prices for a particular period of time selected by a consumer, a merchandiser, or an electronic commerce website.

In traditional electronic commerce markets, merchandisers typically sell products and/or services to consumers at a fixed price. The only option the consumers have is to purchase the product or service at the fixed price, purchase the product when the product goes on sale, or refrain from purchasing the product or service. However, many consumers still wish to enjoy some of the elements of offline shopping in an online environment, for example, bargaining. Some of the platforms that offer online shopping services include a reversed auction, where there is one consumer and multiple merchandisers. In one platform, the consumer has only one chance to name a price. Once the price is named, the merchandisers decide to either accept or reject the offer. The merchandiser who accepts the consumer's offer first gets the deal. Therefore, there is a need for managing online bargaining sessions between merchandisers and consumers in a given time interval to increase satisfaction of the consumers and merchandisers.

Currently, most of the online shopping services conduct the sale at irregular periods. Sometimes, it so happens that even though a consumer may be interested in purchasing a product, the consumer may not be available at the time window when such purchases can be made or to engage in a sale or a bargaining session. Hence, there is a need for determining an optimal time interval or providing consumers and merchandisers the flexibility to select a time interval that is convenient for the consumers and the merchandisers to engage in a fixed price sale or a bargain sale.

Hence, there is a long felt but unresolved need for a computer implemented method and system that facilitates a time interval based sale of sale items in an online environment, where the consumers are provided with special deals on sale items for a particular period of time, are allowed to bargain with merchandisers during a particular period of time, and are also provided with a wide range of discount offers across different time intervals.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for facilitating a time interval based sale of sale items in an online environment, where the consumers are provided with special deals on sale items for a particular period of time, are allowed to bargain with multiple merchandisers during a particular period of time, and are also provided with a wide range of discount offers across different time intervals.

A sale management platform is provided to multiple consumers and multiple merchandisers in an online environment. The sale management platform acquires multiple sale items and sale information associated with the sale items from the merchandisers. As used herein, the term “sale items” refers to products and services offered for sale by the merchandisers. The sale information comprises, for example, a time interval for a sale of the sale items at sale discount prices offered by each of the merchandisers, sale discount prices for the sale items during the merchandiser-selected time interval, sale discount prices for the sale items during the consumer-selected time interval, etc. The sale management platform also acquires a time interval selected for each of the consumers, for example, based on their purchase behavior, search, location, interests, etc. In an embodiment, the sale management platform also acquires a time interval selected by each of the consumers.

In an embodiment, the sale management platform registers the consumers and the merchandisers on the sale management platform and creates consumer accounts and merchandiser accounts respectively. In an embodiment, the sale management platform allows the consumers to set preferences for engaging in the sale and for indicating an interest in purchasing and/or bargaining for the sale items during the merchandiser-selected time interval, the consumer-selected time interval, or an optimal time interval determined by the sale management platform. The consumers set preferences, for example, by tagging of one or more sale items and one or more of the merchandisers as favorites, by setting a preferred time interval for engaging in a sale, etc. The sale management platform authenticates the merchandisers and provides secure access of the sale management platform to each of the authenticated merchandisers.

The sale management platform enables the consumers to search for the sale items and the sale information on the sale management platform. The sale management platform also enables the consumers to select one or more of the sale items for purchase. In an embodiment, the sale management platform further selects one or more of the merchandisers from whom the sale items selected by the consumers can be purchased. In another embodiment, the sale management platform selects one or more of the consumers for engaging in a sale of one or more of the sale items with the selected merchandisers, for example, based on the consumer-selected time interval, bid prices offered by the consumers, etc. In another embodiment, the sale management platform selects one or more of the merchandisers to engage in the sale, for example, based on the sale discount prices, the consumer-selected time interval, preferences set by the consumers, reputation of the merchandisers, value-added services offered by the merchandisers, quality of the sale items offered for the sale by the merchandisers, etc. The sale management platform, in communication with the merchandisers, determines the optimal time interval, the sale discount prices for bargaining sessions, and the quantity of the sale items to be offered for the sale on the sale management platform.

Moreover, the sale management platform determines an optimal time interval for the sale of the selected sale items based on predetermined time criteria. The predetermined time criteria for determining the optimal time interval comprise, for example, one or more of the sale discount prices for the sale items, the consumer-selected time interval, the merchandiser-selected time interval, sale activity of the sale items, a time interval selected by the sale management platform, a time interval selected by purchase behavior of the consumers, a search initiated by one or more of the consumers, purchase behavior of a unique group of consumers, etc. As used herein, the term “sale activity” refers to, for example, past sale records of the sale items, demand for the sale item at a particular time interval, purchasing activity of the consumers, etc.

The sale management platform determines optimal discount prices for the selected sale items based on, for example, the sale discount prices offered by each of the merchandisers, the acquired sale information, a fixed percentage of a list price of each of the selected sale items, and predetermined price criteria. The predetermined price criteria for determining the optimal discount prices for the selected sale items comprise, for example, one or more of demand for the selected sale items, demand for the selected sale items during the merchandiser-selected time interval, the consumer-selected time interval, or the optimal time interval, and mutually agreed conditions by the merchandisers and the sale management platform. In an embodiment, the sale management platform computes discounts on the maximum selling price of each of the sale items. The sale management platform offers the sale items at the computed discounts for the sale at the consumer-selected time interval, the merchandiser-selected time interval, or the optimal time interval.

The sale management platform manages sale of the selected sale items at one or more of the sale discount prices offered by the merchandisers and the optimal discount prices during the merchandiser-selected time interval, the consumer-selected time interval, or the optimal time interval. The sale of the selected sale items is a fixed price sale or a bargain sale. The sale management platform conducts the fixed price sale by selling the selected sale items to the consumers during the merchandiser-selected time interval, the consumer-selected time interval, or the optimal time interval at the sale discount prices offered by the merchandisers. The sale management platform conducts the bargain sale by managing multiple bargaining sessions between the merchandisers and the consumers during the merchandiser-selected time interval, the consumer-selected time interval, or the optimal time interval, on receiving a bargaining request from the consumers.

During the bargain sale, the sale management platform communicates the sale discount prices offered by the merchandisers and the optimal discount prices for the selected sale items to the consumers for acceptance or rejection by the consumers. On rejection of the sale discount prices and the optimal discount prices by the consumers, the sale management platform receives one or more bid prices countering the sale discount prices and the optimal discount prices from the consumers and communicates the countering bid prices to the merchandisers for acceptance or rejection by the merchandisers. The bargaining sessions continue until the expiration of the merchandiser-selected time interval, the consumer-selected time interval, or the optimal time interval, or acceptance of an offer. In an embodiment, the fixed price sale or the bargain sale is conducted during an extended time interval set by the merchandisers or the sale management platform, where the extended time interval exceeds the merchandiser-selected time interval, the consumer-selected time interval, or the optimal time interval. In an embodiment, the bargaining sessions continue until the expiration of the extended time interval beyond the merchandiser-selected time interval, the consumer-selected time interval, or the optimal time interval.

In an embodiment, the sale management platform requests the consumers for payment information. The sale management platform charges the consumers for the selected sale items using the payment information on acceptance of the offer during the merchandiser-selected time interval, the consumer-selected time interval, or the optimal time interval. The sale management platform determines the number of bargaining sessions between the merchandisers and the consumers, the time interval for each of the bargaining sessions, and the time interval for each sale. The sale management platform manages visibility of the sale discount prices to the consumers and the merchandisers.

The sale management platform sends notifications to the merchandisers and the consumers with information on the merchandiser-selected time interval, the consumer-selected time interval, the optimal time interval, a time interval triggered by a sale activity, the sale discount prices offered during the consumer-selected time interval, during the merchandiser-selected time interval, and during the optimal time interval, information of the sale based on preferences set by the consumers, and information of a completed sale. The sale management platform notifies the consumers of the sale discount prices of the selected sale items before initiation of the fixed price sale or the bargain sale of the selected sale items to be held at the merchandiser-selected time interval, the consumer-selected time interval, or the optimal time interval.

In an embodiment, the sale management platform stores information on the sale items in demand, preferences set by the consumers, the consumers who showed interest in the sale items offered for the sale by the merchandisers in a database, and retrieves the information for display to the merchandisers.

In another embodiment, the sale management platform generates consumer profiles accessible by the merchandisers for facilitating targeted advertising by the merchandisers and for conducting a sale of targeted sale items at the merchandiser-selected time interval, the consumer-selected time interval, or the optimal time interval. The sale management platform, in communication with the merchandisers, determines quantity of the sale items to be offered for the sale during the consumer-selected time interval, the merchandiser-selected time interval, and the optimal time interval, and determines a period of the optimal time interval, for example, a few minutes to a few hours or a few days for each sale.

In an embodiment, the sale management platform triggers the time interval based sale of the sale items, for example, based on demographic information of the consumers, a unique group of consumers, initiation of a search for the sale items by the consumers, group purchase of the sale items, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIGS. 1A-1B illustrate a computer implemented method for facilitating a time interval based sale of sale items in an online environment.

FIGS. 2A-2B exemplarily illustrate a computer implemented method for facilitating purchasing and/or bargaining in a time interval and charging a consumer on acceptance of an offer.

FIG. 3 exemplarily illustrates management of a fixed number of bargaining sessions by a sale management platform.

FIG. 4 exemplarily illustrates a computer implemented method for sending notifications about a time interval based sale of sale items to a consumer by the sale management platform.

FIG. 5 exemplarily illustrates options presented to a merchandiser by the sale management platform.

FIG. 6 illustrates a computer implemented system for facilitating a time interval based sale of sale items in an online environment.

FIG. 7 exemplarily illustrates the architecture of a computer system employed by the sale management platform for facilitating a time interval based sale of sale items in an online environment.

FIGS. 8A-8F exemplarily illustrate a flow chart comprising the steps for allowing consumers to engage in a fixed price sale or a bargain sale in an online environment.

FIG. 9 exemplarily illustrates determination of an optimal discount price for a sale item based on multiple factors by the sale management platform.

FIG. 10 exemplarily illustrates determination of an optimal time interval for a fixed price sale or a bargain sale based on multiple factors by the sale management platform.

FIG. 11 exemplarily illustrates determination of quantity of sale items to be offered for sale by the sale management platform.

### DETAILED DESCRIPTION OF THE INVENTION

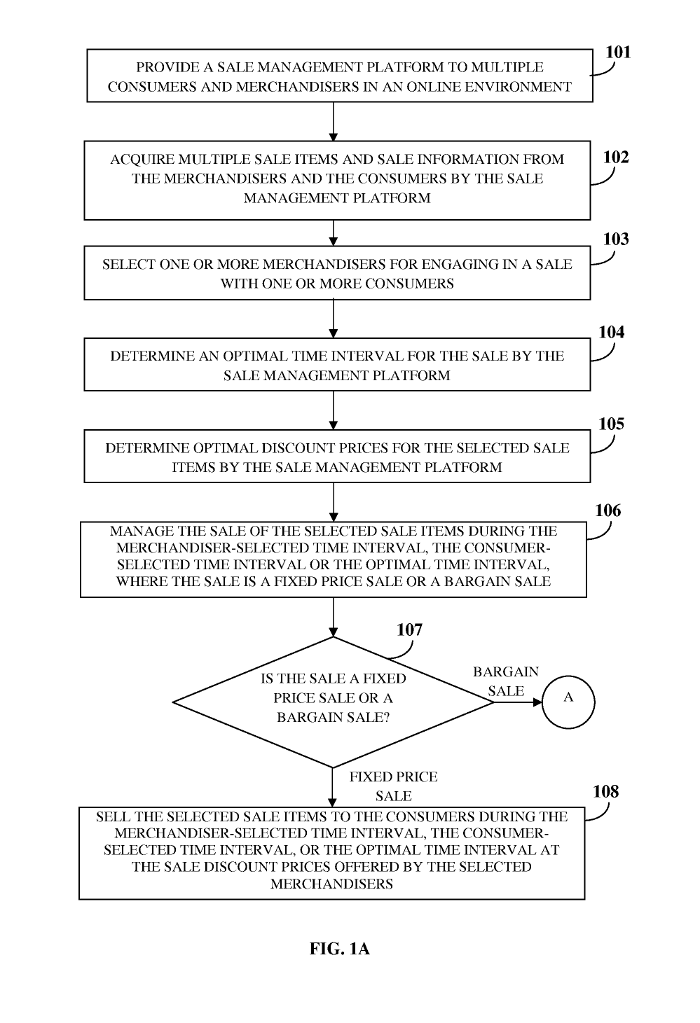

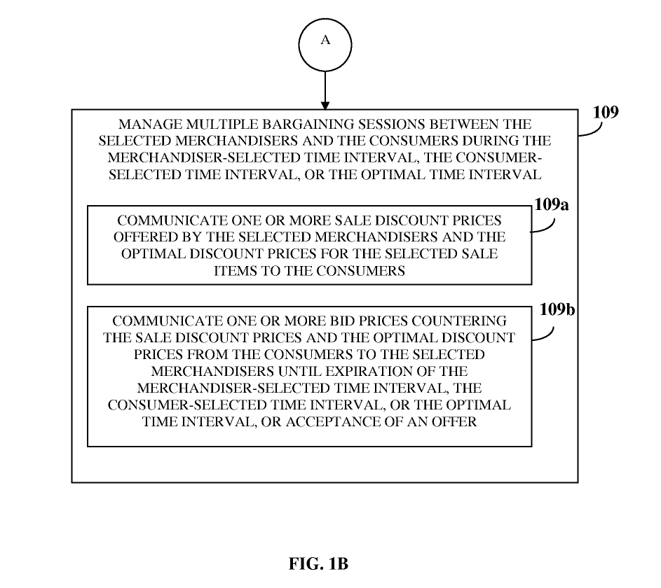

FIGS. 1A-1B illustrate a computer implemented method for facilitating a time interval based sale of sale items in an online environment. A sale management platform is provided 101 to multiple consumers and multiple merchandisers in the online environment. As used herein, the term “consumers” refers to customers, potential buyers of sale items, etc., who have access to the online environment, for example, the world wide web. In an embodiment, the sale management platform hosts a website accessible to the consumers and the merchandisers via a network. The sale management platform disclosed herein provides special offers or deals on products and services for a particular time interval ranging, for example, from a few minutes to a few hours or a few days. For example, the sale management platform allows a consumer to engage in a fixed price sale, where the consumer can purchase a sale item at a fixed sale discount price offered by a merchandiser at a particular time interval. As used herein, the term “fixed price sale” refers to a sale conducted by the sale management platform without negotiation of the sale discount prices offered by the merchandisers. Furthermore, the sale management platform allows the consumer to engage in a bargain sale, where the consumer can bargain with merchandiser and purchase a sale item at a bargain price. As used herein, the term “bargain sale” refers to a sale conducted by the sale management platform where the consumers are allowed to negotiate the sale discount prices offered by the merchandisers and bargain with them in the given time interval.

The sale management platform acquires 102 new and old products and services, herein referred to as “sale items” offered for sale from the merchandisers. The sale management platform also acquires sale information comprising, for example, a time interval for a sale of the sale items at sale discount prices offered by each of the merchandisers, a time interval selected by each of the consumers, etc., associated with the sale items from the merchandisers and the consumers. As used herein, the term “time interval” refers to a period of time ranging from, for example, a few minutes, a few hours, or a few days, during which the sale items are offered at discounted prices and during which the discounted prices can be negotiated. The time interval selected by the merchandisers on the sale management platform for a fixed price sale or a bargain sale of the sale items at sale discount prices is herein referred to as a “merchandiser-selected time interval”. The time interval selected by the consumers on the sale management platform to engage in a fixed price sale or a bargain sale with the merchandisers is herein referred to as “consumer-selected time interval”. As used herein, the term “discount” refers to the amount of price reduction from the original manufacturer's suggested selling price.

The sale management platform also acquires sale information, for example, sale discount prices for the sale items during the merchandiser-selected time interval, sale discount prices for the sale items during the consumer-selected time interval, quantity and quality description of the sale items, etc., from the merchandisers. The sale management platform manages visibility of the sale discount prices to the consumers and the merchandisers. The sale management platform enables the consumers to search for the sale items and the sale information on the sale management platform. The sale management platform also enables the consumers to select one or more of the sale items for purchase.

The sale management platform selects 103 one or more of the merchandisers for engaging in a sale of one or more of the sale items selected by the consumers, for example, based on the sale discount prices, the consumer-selected time interval, preferences set by the consumers, reputation of the merchandisers, value-added services offered by the merchandisers, quality of the sale items offered for sale by the merchandisers, etc. The sale management platform determines 104 an optimal time interval for the sale of the selected sale items based on predetermined time criteria. The predetermined time criteria for determining the optimal time interval comprise, for example, one or more of the sale discount prices offered by the merchandisers for the sale items at different time intervals, the consumer-selected time intervals, the merchandiser-selected time intervals, sale activity of the sale items such as past sale records of the sale items, demand for the sale item at a particular time interval, purchasing activity of consumers, a time interval selected by the sale management platform, a time interval selected by purchase behavior of the consumers, a search initiated by one or more of the consumers, purchase behavior of a unique group of consumers, etc. In an embodiment, the sale management platform determines the optimal time interval based on number of purchases made by the consumers. For example, the sale management platform selects a time interval such as a few hours on a weekend for the sale on determining that a consumer has made five purchases on the weekend.

In an embodiment, the sale management platform selects one or more of the consumers for engaging in a sale of one or more of the sale items with the merchandisers during the merchandiser-selected time interval, the consumer-selected time interval, or for online bargaining with the merchandisers based on bid prices quoted by the consumers. For example, the sale management platform selects the consumer who quotes the highest bid price for a selected sale item to engage in online bargaining with the merchandisers. The sale management platform then selects one or more merchandisers that offer low sale discount prices or the lowest sale discount prices for the selected sale item for online bargaining. For example, if a merchandiser A, a merchandiser B, and a merchandiser C offer a television set for sale discount prices of $1000, $1200, and $1500 respectively, the sale management platform selects merchandiser A for online bargaining on the sale management platform, as merchandiser A offered the lowest sale discount price for the television set.

In an embodiment, the sale management platform discloses the lowest sale discount price referred to as a mega hour price on the website hosted by the sale management platform minutes or hours before the time interval or mega hour begins. As used herein, the term “mega hour” refers to the time interval during which the merchandisers provide a discounted price for the sale items. The sale management platform displays the mega hour prices offered by each of the merchandisers for each of the sale items. The consumers can purchase the sale items at the mega hour price by logging onto the sale management platform at the mega hour.

The sale management platform determines 105 or computes optimal discount prices for the selected sale items, for example, based on the sale discount prices offered by each of the merchandisers, the acquired sale information, a fixed percentage of a list price of each of the sale items, and predetermined price criteria. The predetermined price criteria for determining the optimal discount prices for the selected sale items comprise, for example, one or more of demand for the sale items, demand for the sale items during the merchandiser-selected time interval, the consumer-selected time interval, and/or the optimal time interval, and mutually agreed conditions by the merchandisers and the sale management platform. In an example, if merchandiser A offers the television set for a sale discount price of $1000, the sale management platform determines an optimal discount price of $600 for the television set based on demand and a mutual agreement with merchandiser A. Fixed price criteria may also be included under the mutually agreed conditions.

In an embodiment, the sale management platform determines the optimal discount price based on a predetermined number of purchases made by the consumers. For example, the sale management platform reduces the sale discount price of a video camera from the list price of $450 to $250, only if 20 consumers purchase the video camera. Otherwise, the sale management platform sells the video camera for the list price without any price reduction. In an embodiment, the sale management platform reduces the sale discount price of a video camera from the list price to a lower price based on the number of video cameras purchased by the consumers during a time interval set by the merchandiser.

The sale management platform manages 106 the sale of the selected sale items at one or more of the sale discount prices offered by the merchandisers and the optimal discount prices during the merchandiser-selected time interval, the consumer-selected time interval, or the optimal time interval, where the sale of the selected sale items is a fixed price sale or a bargain sale. The sale management platform determines 107 whether the consumer wishes to engage in the fixed price sale or the bargain sale. The sale management platform conducts the fixed price sale by selling 108 the selected sale items to the consumers during the merchandiser-selected time interval, the consumer-selected time interval, or the optimal time interval at the sale discount prices offered by the merchandisers or the sale management platform. The sale management platform conducts the bargain sale by managing 109 multiple bargaining sessions between the merchandisers and the consumers during the merchandiser-selected time interval, the consumer-selected time interval, or the optimal time interval, on receiving a bargaining request from the consumers.

In an embodiment, the fixed price sale or the bargain sale is conducted during an extended time interval set by the merchandiser or the sale management platform, where the extended time interval exceeds the merchandiser-selected time interval, the consumer-selected time interval, or the optimal time interval. In an embodiment, the bargaining sessions continue until the expiration of the extended time interval set by the merchandisers or the sale management platform beyond the merchandiser-selected time interval, the consumer-selected time interval, or the optimal time interval.

During management of the bargaining sessions, the sale management platform communicates 109a one or more of the sale discount prices offered by the merchandisers and the optimal discount prices for the selected sale items to the consumers for acceptance or rejection by the consumers. If the consumers reject the sale discount prices offered by the merchandisers and the optimal discount prices, the sale management platform communicates 109b one or more bid prices countering the sale discount prices and the optimal discount prices from the consumers to the merchandisers until expiration of the merchandiser-selected time interval, the consumer-selected time interval, or the optimal time interval, or acceptance of an offer.

Consider an example where the sale management platform presents the offered low or the lowest sale discount prices and the optimal discount prices for the selected sale items to the consumers during a time interval for acceptance or rejection by the consumers. In the detailed description herein, the merchandiser-selected time interval, the consumer-selected time interval, or the optimal time interval is referred to simply as the “time interval”. If the consumers reject the offered low or lowest sale discount prices and the optimal discount prices, the sale management platform receives countering bid prices from the consumers for the selected sale items during the time interval. In this manner, the sale management platform iteratively communicates the low or lowest sale discount prices offered by the merchandisers and the optimal discount prices for the selected sale items to the consumers, and the countering bid prices received from the consumers to the merchandisers during the time interval until expiration of the time interval or acceptance of an offer. For example, if the sale is not complete, the sale management platform conducts a second bargaining session between the consumers and the merchandisers during the time interval or during an extended time interval set by the merchandiser or the sale management platform. In an embodiment, the sale management platform determines the number of bargaining sessions and the time interval for each of the bargaining sessions, and the time interval for each sale. The sale management platform considers the sale to be complete when the consumer and the merchandiser agree on the predetermined price criteria and the sale discount price for the sale item.

The sale management platform therefore facilitates the time interval based sale of sale items in the online environment by sale during the merchandiser-selected time interval, sale during the consumer-selected time interval, sale during the optimal time interval, or by managing online bargaining during the merchandiser-selected time interval, the consumer-selected time interval, or the optimal time interval approved by the sale management platform. The consumers can purchase the sale items during the merchandiser-selected time interval, the consumer-selected time interval, or the optimal time interval until the time interval expires or until the number of items on sale are sold during a particular time interval, or during an extended time interval set by the merchandiser or the sale management platform. When the sale items are sold or the time interval expires the sale is closed for that particular period of time interval. If the items for sale are still remaining at the end of the time interval, the sale management platform decides the future time interval when those items will be offered for sale. The consumers can purchase items even during regular hours by paying the regular sale price. The quantity of sale items sold in a time interval is determined by the merchandiser and the sale management platform.

In an embodiment, the sale management platform triggers the time interval based sale of the sale items based on demographics, for example, location, age, income, etc., of the consumers or for a unique group of consumers. For example, the sale management platform triggers the time interval based sale of the sale items for a group of consumers, for example, college students, police officers, etc., and presents the lowest sale discount prices to the selected group of consumers only. In another example, the sale management platform presents different lowest sale discount prices to different consumers for the same sale item at the same time interval or different time intervals based on, for example, their location, income, sale activity, etc., and other criteria defined by the sale management platform. In another embodiment, the sale management platform triggers the time interval based sale of the sale items based on group purchase of the sale items. For example, the sale management platform triggers the time interval based sale of the sale items when a particular group of consumers purchase particular types of sale items in groups.

In another embodiment, the sale management platform triggers the time interval based sale of the sale items based on an initiation of a search for the sale items by the consumers. For example, when a consumer initiates a search for size 9½ Adidas® shoes of Adidas AG Joint Stock Company on the sale management platform, the search triggers the time interval based sale of the size 9½ Adidas shoes. The sale management platform presents the size 9½ Adidas shoes for a sale beginning at the time of the search and lasting for 45 minutes, at the lowest sale discount price.

In an embodiment, the sale management platform requests the consumers for payment information, for example, credit card information before initiation of a fixed price sale or the bargain sale or before they quote their bid prices on the sale management platform. The sale management platform charges the consumers for the sale items using the payment information on acceptance of an offer during the merchandiser-selected time interval, the consumer-selected time interval, or the optimal time interval.

Consider an example where the sale management platform hosts a website for an online sale of sale items with a discounted price at a particular time interval determined by the merchandiser and the sale management platform. The sale management platform acquires information on television sets to be offered for sale on the website by a merchandiser A, a merchandiser B, and a merchandiser C. Merchandiser A, merchandiser B, and merchandiser C offer a television set for sale discount prices of $1000, $1200, and $1500 respectively. The sale management platform selects merchandiser A for online bargaining on the sale management platform, as merchandiser A offered the lowest sale discount price for the television set. The sale management platform then determines an optimal discount price of $600 for the television set based on demand and a mutual agreement with merchandiser A.

Multiple consumers, for example, a consumer P, a consumer Q, a consumer R, a consumer S, and a consumer T select the television set. The consumers have to option to engage in a fixed price sale or a bargain sale. If the consumers wish to engage in the fixed price sale, the consumers can purchase the television set at $1000 offered by merchandiser A on the sale management platform. If the consumers wish to engage in the bargain sale, the sale management platform opens bidding at a minimum of $200 for a time interval of 10 hours. The consumers, for example, consumer P, consumer Q, consumer R, consumer S, and consumer T select the television set and quote bid prices of $220, $250, $200, $300, and $280 respectively. The sale management platform selects consumer S to engage in online bargaining with merchandiser A, as consumer S quoted the highest bid price of $300. The sale management platform presents the bid price of $300 quoted by consumer S to merchandiser A. If merchandiser A does not agree with the bid price, the sale management platform starts a second bargaining session with merchandiser A, merchandiser B, and merchandiser C. The sale management platform allows consumer P, consumer Q, consumer R, consumer S, and consumer T to quote bid prices in the second bargaining session. In the second bargaining session, if the bid prices quoted by consumer P, consumer Q, consumer R, consumer S, and consumer T are $260, $450, $500, $350, and $400 respectively, the sale management platform selects consumer R to engage in online bargaining with merchandiser A, as consumer R quoted the highest price of $500 in the second bargaining session. If the sale is not complete, the sale management platform starts another bargaining session until the time interval expires. The number of bargaining sessions and the time interval vary for each sale.

In an embodiment, the sale management platform allows the merchandisers and the consumers to make a predetermined number of sale discount price offers and countering bid price offers respectively during a particular time interval. The sale management platform allows online bargaining between a single consumer and a single merchandiser, multiple consumers and a single merchandiser, a single consumer and multiple merchandisers, or between multiple consumers and multiple merchandisers. When multiple consumers and merchandisers are involved, the sale management platform selects the consumer who quotes the highest bid price to bargain with the merchandiser who quotes the lowest sale discount price. The merchandiser who quotes the lowest discount price can also negotiate with multiple consumers individually.

In an embodiment, the sale management platform enables the consumers to search for the sale items and the sale information on the sale management platform. If the consumer finds a sale item of interest to him/her on discount at a particular time interval, the consumer can proceed to purchase the discounted sale item if interested. The consumer may also decide to enter into a bargaining session for one or more of the sale items during the time interval selected by the merchandisers and the sale management platform. For example, a consumer may conduct a search for sale items, for example “five star hotels” and “las vegas” on the sale management platform. The sale management platform lists a few five star hotels located in Las Vegas. The consumer can then start the bargain with all of the listed hotels or with a selected hotel. In another example, a consumer may conduct a search for a sale item such as “Ford”, “year 2002-2005”, “30K-50K miles”, and “Los Angeles, Calif.”. The sale management platform lists all the relevant results and the consumer can make counter bid price offers on all of the listed cars or on a particular car that interests the consumer. If the sale is not completed after the consumer places the allowed number of counter bid price offers, the consumer will not be allowed to purchase the sale item for a predetermined period of time.

If the entire sale items are sold in a time period before the merchandiser-selected time interval, the consumer-selected time interval, or the optimal time interval expires, there will not be any more sale items for sale on the sale management platform and the sale is closed for that particular time interval. If some of the sale items remain unsold at the sale during a particular time interval, the sale management platform determines the future placement of the sale items for the discount sale and the next optimal time interval. Moreover, the sale management platform enables the consumers to purchase the sale items during the merchandiser-selected time intervals, the consumer-selected time intervals, the optimal time intervals, or during regular hours. The consumers may purchase the sale items during the regular hours by paying the list price for the sale items.

In an embodiment, the sale management platform registers consumers and merchandisers on the sale management platform for creating consumer accounts and merchandiser accounts respectively. In an embodiment, a website hosted by the sale management platform provides consumers an option to register on the sale management platform to avail certain benefits provided by the sale management platform. In an embodiment, the sale management platform allows unregistered consumers and registered consumers to make purchases on the sale management platform during the merchandiser-selected time interval, the consumer-selected time interval, and the optimal time interval. The sale management platform allows registered consumers to avail certain benefits provided by the sale management platform, for example, loyalty benefits, additional discounts, updates on favorite sale items, etc. The consumers provide information, for example, contact details, dates, favorite category of sale items, sale items of special interest, etc., for association with the consumer accounts.

The consumers may also provide feedback on each merchandiser. The feedback is used to rate the profile of each of the merchandisers on the sale management platform. The sale management platform sends latest updates on the discounts on the sale items to the registered consumers.

In an embodiment, the sale management platform enables the consumer to name his/her time interval price for a particular sale item. If the named price is accepted by the merchandiser the sale is complete; if not, the sale management platform provides the consumer additional iterations to name the price until the time interval expires.

In an embodiment, the sale management platform generates consumer profiles accessible by the merchandisers for facilitating targeted advertising by the merchandisers or for targeting particular consumers with sale items and discount offers, for example, based on their purchasing patterns, preferred time intervals, preferred merchandisers, preferred sale items, etc. The sale management platform uses the purchasing patterns and preferences of the consumers to generate the consumer profiles. Moreover, the sale management platform provides allows the merchandisers to target the sale items of the merchandisers to the consumers based on the generated consumer profiles. The sale management platform conducts a fixed price sale or a bargain sale of the targeted sale items at the merchandiser-selected time interval, the consumer-selected time interval, or the optimal time interval. The sale management platform allows the merchandisers to advertize on the sale management platform for a fee. The sale management platform facilitates the advertising, for example, by posting the merchandiser's advertisements on the webpage of the consumer account.

Consider an example where the sale management platform develops a consumer profile for consumer P. The consumer profile indicates that consumer P has a preference for purchasing electronic gadgets online, prefers merchandisers from Japan, and prefers to shop during the weekends. Merchandiser Z from Japan selling electronic gadgets accesses the consumer profile of consumer P from the sale management platform. Merchandiser Z then opts to advertise to consumer P via the sale management platform and provide a time interval based sale of electronic items. The sale management platform, on receiving the request for advertising from merchandiser Z, places an advertisement of the electronic items of merchandiser Z on the webpage of consumer P's account. Therefore, when consumer P logs into consumer P's account, consumer P can view the advertisement of merchandiser Z. Furthermore, consumer P can purchase the sale item advertized by merchandiser Z at a discounted price during a particular time interval on the sale management platform. The sale management platform conducts a sale of targeted sale items at the merchandiser-selected time interval, the consumer-selected time interval, or the optimal time interval.

In an embodiment, the sale management platform categorizes the sale items and displays the categorized sale items on a website hosted by the sale management platform. In an embodiment, the merchandisers and the sale management platform mutually determine the time interval, the sale discount prices for the fixed price sale and the bargain sale, and the quantity of sale items to be offered for sale on the sale management platform. The sale management platform then renders the time interval, the sale discount prices, and the number of items for sale on the sale management platform.

The sale management platform, in communication with the merchandisers, determines quantity of the sale items to be offered for the sale during the consumer-selected time interval, the merchandiser-selected time interval, and the optimal time interval, and determines a period of the optimal time interval, for example, a few minutes to a few hours or a few days, or determines whether to extend the time interval beyond the consumer-selected time interval, the merchandiser-selected time interval, or the optimal time interval for each sale.

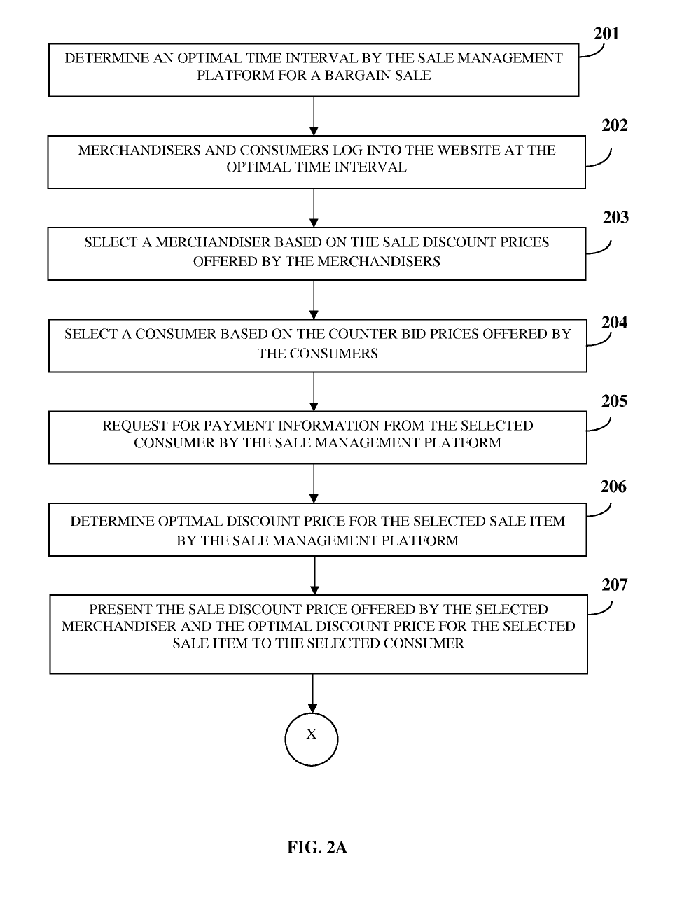

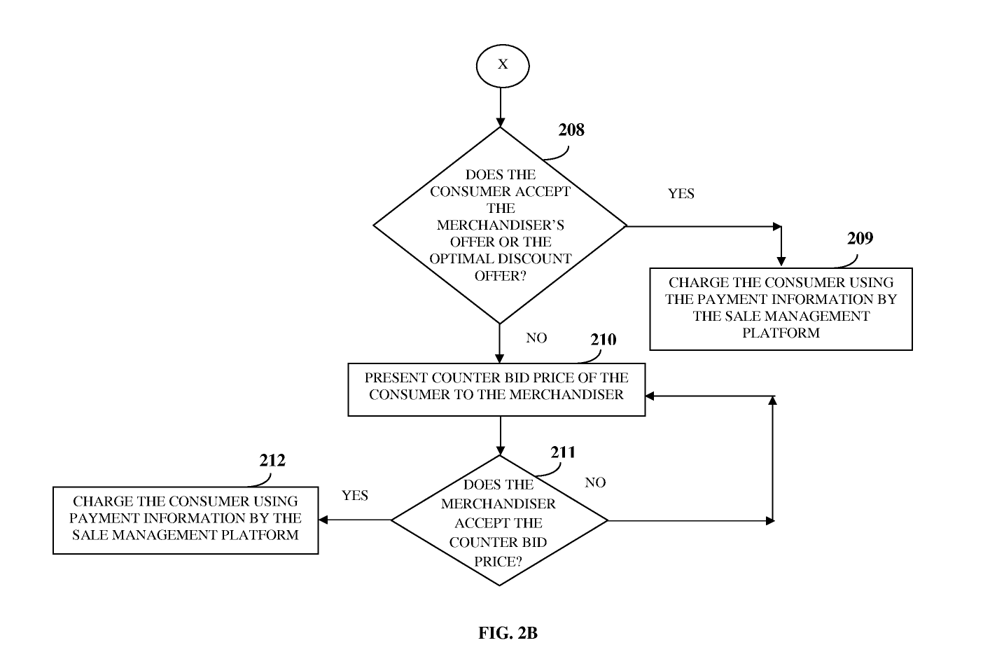

FIGS. 2A-2B exemplarily illustrate a computer implemented method for facilitating purchasing and/or bargaining in a time interval and charging a consumer on acceptance of an offer. The sale management platform determines 201 an optimal time interval for sale, for example, a bargain sale, of the sale items. The sale management platform displays the optimal time interval on a website hosted by the sale management platform. Consumers and merchandisers who intend to purchase and sell sale items respectively, log 202 into the website of the sale management platform at the optimal time interval. At the optimal time interval, consumers have the option of either purchasing a sale item without bargaining, or purchasing a sale item after bargaining. The sale management platform displays the sale discount prices of the sale items offered by multiple merchandisers on the website. The sale management platform selects 203 a merchandiser based on the sale discount prices offered by the merchandisers. In an example, the sale management platform selects the merchandiser who offers the lowest sale discount price. For example, if a merchandiser A, a merchandiser B, and a merchandiser C offer a television set for sale discount prices of $1000, $1200, and $1500 respectively, the sale management platform selects merchandiser A for online bargaining on the sale management platform, as merchandiser A offered the lowest sale discount price for the television set.

The sale management platform then requests the consumers to present counter bid prices. The sale management platform selects 204 a consumer based on the counter bid prices offered by the consumers. In an example, the sale management platform selects the consumer who offers the highest counter bid price. The sale management platform then requests 205 for payment information from the selected consumer. The sale management platform determines 206 an optimal discount price for the sale item selected by the selected consumer. The sale management platform presents 207 the sale discount price offered by the merchandiser and the optimal discount price for the selected sale item to the selected consumer.

The sale management platform checks 208 if the consumer has accepted the sale discount price offered by the merchandiser or the optimal discount price. If the consumer accepts either the sale discount price offered by the merchandiser or the optimal discount price, the sale management platform charges 209 the consumer using the payment information and completes the sale. In an example, the sale management platform requests for the credit card details of the consumer and on acceptance of an offer by the consumer, the sale management platform charges the consumer from the consumer's credit card.

If the consumer does not accept the sale discount price offered by the merchandiser or the optimal discount price, the sale management platform requests a counter bid price from the consumer. The sale management platform presents 210 the counter bid price of the consumer to the merchandiser. In an example, the counter bid price is a price range of $400-$500. The sale management platform checks 211 whether the merchandiser has accepted the consumer's counter bid price offer. If the merchandiser agrees to sell the sale item in the price range of $400-$500, then the sale management platform charges 212 the consumer from the deposit using the payment information and completes the sale. If the merchandiser does not agree to sell the sale item for the price range of $400-$500, the consumer makes additional counter bid price offers in higher price ranges and continues the negotiation. The sale management platform presents 210 these additional counter bid price offers to the merchandiser. After a predetermined number of attempts, if none of the merchandisers agrees to sell for the consumer's price ranges, the sale management platform closes the sale and does not allow the consumer to bid for that sale item for a predetermined period of time. Furthermore, if the time interval for bargaining expires, the sale management platform closes the sale for the selected item. When the transaction is completed and accepted, the sale management platform delivers the sale item to the consumer, for example, through shipping, electronic mail, hand delivery, etc. In order for a consumer to be able to return the sale item, the consumer needs to abide by return rules defined by the sale management platform.

Consider an example where the sale management platform opens bidding at a minimum of $200 for a time interval of 10 hours. Multiple consumers, for example, a consumer P, a consumer Q, a consumer R, a consumer S, and a consumer T select a particular television set and quote bid prices of $220, $250, $200, $300, and $280 respectively. The sale management platform selects consumer S to engage in online bargaining with merchandiser A, as consumer S quoted the highest bid price of $300. The sale management platform manages multiple bargaining sessions between the selected consumer and the merchandiser during the optimal time interval. The sale management platform presents the lowest sale discount price and an optimal discount price for the selected sale item to the selected consumer for acceptance or rejection by the selected consumer.

The sale management platform determines the optimal discount price for the selected sale item based on, for example, the sale discount prices offered by each of the merchandisers for the sale item, the acquired sale information, a fixed percentage on a list price of the sale item, and predetermined price criteria. The predetermined price criteria comprise, for example, demand for the sale items, demand for the sale items during the optimal time interval, and mutually agreed conditions by the merchandisers and the sale management platform. In an example, if merchandiser A offers the television set for a sale discount price of $1000, the sale management platform determines an optimal discount price of $600 for the television set based on demand and a mutual agreement with merchandiser A.

If the selected consumer rejects both the lowest sale discount price and the optimal discount price for the selected sale item, the sale management platform receives a counter bid price from the selected consumer. In this manner, the sale management platform iteratively communicates the sale discount prices offered by the merchandiser and the optimal discount prices for the selected sale items to the consumers, and the counter bid prices received from the selected consumer to the merchandiser until expiration of the optimal time interval or acceptance of an offer. The sale management platform therefore allows the consumer and the merchandiser to negotiate the sale price of the sale item during a particular time interval.

The sale management platform allows the merchandiser to make a discount offer by decreasing or increasing the price of the sale item. Moreover, the sale management platform allows the selected consumer to make a counter bid offer by increasing or decreasing the price in the time interval. The sale management platform determines the optimal discount price for each discount offer and counter bid offer made by the merchandiser and the consumer respectively.

In an embodiment, the sale management platform allows consumers to select merchandisers based on additional criteria, for example, reputation of the merchandiser, value-added services offered by the merchandiser, preferences set by the consumer, consumer-selected time interval, quality of the products and services offered for sale by the merchandiser, etc. The term “value-added services” refers to all non-core services provided by the merchandisers to promote their main business, for example, free home delivery of products, round the clock toll free number for any assistance, etc. The sale management platform evaluates the reputation of the merchandisers using factors comprising, for example, awards and testimonials received by the merchandisers, reliability of the merchandisers, etc. In an example, the sale management platform may request the consumer to set his/her preference for selection of the merchandisers, wherein the selection ranges from the offered sale price, reputation of the merchandiser, the value-added services by the merchandiser, quality of the products and services offered by the merchandiser, to a combination of two or more of the above factors.

Consider an example where the sale management platform provides an option to choose between merchandiser A, or to let the sale management platform choose a merchandiser after taking into account additional factors, for example, reputation, value-added services offered by the merchandiser, preferences set by the consumer, the consumer-selected time interval, and quality of the products and services offered for sale by the merchandiser. For example, if the consumer has opted for free-home delivery of the selected sale items, which is a type of value-added service, the sale management platform selects merchandiser A, who offered the lowest sale discount price, only if merchandiser A also offers free-home delivery. If not, the next merchandiser who offers the next lowest sale discount price and offers free-home delivery is selected.

The sale management platform starts managing the bargaining session on the website during the optimal time interval. Consider an example where a bargaining session takes place between merchandiser A and the selected consumer S. In this example, the sale management platform allows merchandiser A to make a sale discount price offer by decreasing or increasing the price and allows consumer S to make a counter bid price offer by increasing or decreasing the price. The sale management platform determines an optimal discount price for each sale discount price offer and counter bid price offer made by merchandiser A and consumer S respectively.

The bargaining session that takes place between merchandiser A and the selected consumer S is exemplarily tabulated below:

| MERCHANDISER | SALE MANAGEMENT | CONSUMER S'S |
|---|---|---|
| A'S SALE | PLATFORM'S OPTIMAL | COUNTER |
| DISCOUNT PRICE | DISCOUNT PRICE | OFFER PRICE |
| $1000 | $600 | $300 |
| $900 | $550 | $450 |
| $750 | $550 | $500 |
| $600 | | |

The sale management platform closes the bargaining session if the optimal time interval expires or if one of the offers is accepted by merchandiser A and consumer S. That is, the sale management platform closes the bargaining session if consumer S accepts one of merchandiser A's sale discount price offers, if merchandiser A accepts one of consumer S's counter bid price offers, or if both merchandiser A and consumer S accept the sale management platform's optimal discount price offer. In an embodiment, the sale management platform requests the consumers to provide valid credit card information before making counter offers, and if any of the offers are accepted, the sale management platform charges the consumers' credit card immediately. In an embodiment, the sale management platform selects the time interval for the bargaining session. If the time interval for bargaining expires, the sale of the selected item is closed.

In an embodiment, the consumers can make a counter bid price offer with a range of prices. For example, if a merchandiser offers a digital camera for sale at $100 during the time interval selected by the sale management platform, the consumer can make a counter bid price offer in the price range of $60-$75. The sale management platform communicates with other merchandisers regarding acceptance of this price range. If multiple merchandisers accept to sell the digital camera for that price range, the consumer can select any one of the merchandisers to purchase the digital camera. After the consumer makes the counter bid price offer, the sale management platform charges a deposit higher than the price range on the consumer's credit card. If a merchandiser agrees to sell the digital camera in that price range, the sale management platform charges the consumer from the deposit and completes the sale. If the merchandiser does not agree to sell the digital camera in that price range, the consumer can make additional counter bid price offers with price ranges and continue the negotiation until the expiration of the time interval. After a predetermined number of attempts, if none of the merchandisers agree to sell the digital camera for the consumer's price ranges, the sale management platform closes the sale and the consumer cannot bid for that sale item for a predetermined period of time.

The purpose of enabling consumers and merchandisers to bargain for a predetermined period of time brings serious buyers to the table and from there both the buyers and the merchandisers can negotiate a price. The consumer who quotes the highest bid price is presented to the merchandiser on the sale management platform. If the merchandiser agrees with the bid price, the sale management platform completes the sale and charges the consumer for that amount from the payment information provided by the consumer. The consumer has to provide information of a valid source of payment, for example, a credit card before bidding for sale items on the sale management platform. Furthermore, since the sale management platform selects the consumers who quote the highest bid prices, the expected sale price of the merchandiser may be reached with minimal bargaining to satisfy the requirements of the both the consumer and the merchandiser.

In an embodiment, the sale management platform computes discounts on the maximum selling price of each of the sale items. The discounts vary for each of the consumers, for example, based on location, purchase behavior, loyalty, etc. The sale management platform offers the sale items at the computed discounts for the sale at the merchandiser-selected time interval, the consumer-selected time interval, or the optimal time interval. The sale management platform analyzes multiple parameters to determine the amount of discount to be offered on the sale items and the time interval during which the sale items are offered for sale. In an embodiment, the parameters for determining the amount of discount and the time interval for the discount for a particular sale item comprise, for example, the demand for that particular sale item at a particular time of day, number of consumers viewing that sale item, the category of the sale item, consumer activity at different times on the sale management platform, geographical distance between the consumer and the shipping origin location, etc.

When a sale item or a category of the sale item is consistently purchased during a particular time interval during a particular time of day, the sale management platform analyzes this data based on the purchases recorded by the sale management platform and revises the amount of discount on that particular category of the sale item. If a certain sale item receives a few views and is purchased rarely during a particular time interval, the sale management platform revises the discount as per the analyzed data. For example, an item intended to be sold to a working professional will be on sale on a big discount between 9 a.m. to 6 p.m. on weekdays. The same item will be on sale for a minimum, or no discount during weekends. The same sale item may be sold at a different discount at a different time interval. In another embodiment, the same sale item may be sold at the regular price determined by the merchandiser and the sale management platform at times other than during the time interval. In another embodiment, the sale management platform also allows the consumer and the merchandiser to select the amount of discount and the time interval for the discount provided to each sale item. The sale management platform then displays the discounted sale items for sale on the sale management platform.

In another embodiment, the sale management platform negotiates with the merchandisers on the sale discount price of a sale item to be offered for sale to multiple consumers during the time interval selected by the merchandisers, the consumers, or the sale management platform. The sale management platform also negotiates with the merchandisers on the sale discount price of a sale item to be offered for online bargaining during the time interval selected by the merchandisers, the consumers, or the sale management platform.

Consider an example where the sale management platform hosts a website for an online sale of items with a discounted price at a particular time interval when compared with the original price of the sale items. Consumers visiting the website can view and purchase various sale items for sale at discounted prices on the sale management platform. A registered or an unregistered consumer may visit the website hosted by the sale management platform. The consumer may set up profiles and configure settings and preferences associated with the consumer account. For example, the consumer can request for alerts when sale items of choice are offered at discounted prices. The sale management platform sends alerts to the consumer when a time interval begins on the sale management platform. During the time interval, the consumer can bargain with the merchandisers directly. When the consumer purchases a sale item, the consumer has options to rate the merchandiser from whom the consumer purchased the sale item and add the merchandiser to a favorite merchandiser list.

The sale platform provides a web page describing a sale item in detail with an option to make payments using an online payment facility. When the sale management platform offers a deal for sale items during the time interval, the consumer may click on the sale item to be sold to access an item description page comprising the details of the sale item, the original price, and the discount being offered during the time interval. The sale management platform provides a payment interface that allows the consumer to transmit payment for the sale item. The payment interface comprises fields for capturing electronic payment information and transmits them over secure connections. For example, the fee payment interface may be associated with online payment processing services such as PayPal™ of PayPal, Inc. When the transaction is completed and accepted, the sale management platform delivers the sale item to the consumer, for example, through shipping, electronic mail, hand delivery, etc. If the consumer wants to return the sale item, the consumer needs to abide by the return rules defined by the sale management platform.

The merchandiser along with the website administrator determines the time interval during which a particular sale item will be offered at discounted prices. The sale items can be sold to anyone in the world or to certain geographical locations selected by the sale management platform based on a mutual agreement with that particular merchandiser. The associated information is made available to the consumer for each sale item sold by the sale management platform. The sale management platform may receive a certain percentage of the selling price from the merchandisers on each sale item sold. The consumers and the merchandisers are required to abide by the rules of the sale management platform. The sale management platform may deactivate the accounts of the consumers and merchandisers on failure to abide by the rules.

In another embodiment, the sale management platform allows a consumer to select the time interval to purchase a predetermined sale item from a merchandiser or from multiple merchandisers. The merchandisers can offer their sale discount prices for the time interval selected by the consumer. Consider an example where a consumer wants to purchase a sale item from a merchandiser or from multiple merchandisers at a consumer-selected time interval. For example, if a consumer wants to purchase a television set, the consumer accesses a website hosted by the sale management platform, clicks on an option on a web page, for example, “Name your mega hour”, provides the consumer-selected time interval as “Monday, between 6 p.m.-8 p.m.”, enters the sale item as “26 inch screen high definition television (HDTV) of Sony Electronics Inc.”, and selects a price range of $250-$380 on the web page. The sale management platform charges the consumer for that amount using the consumer's credit card information stored in a database on the sale management platform. If the original price of the Sony HDTV is between $750-$900, multiple merchandisers, for example, merchandiser A, merchandiser B, and merchandiser C can select their sale discount price for the Sony HDTV during the selected time interval as $350, $375, and $500 respectively. The sale management platform selects merchandiser A as the seller, deducts $350 from the deposit charged earlier using the consumer's credit card, and completes the sale.

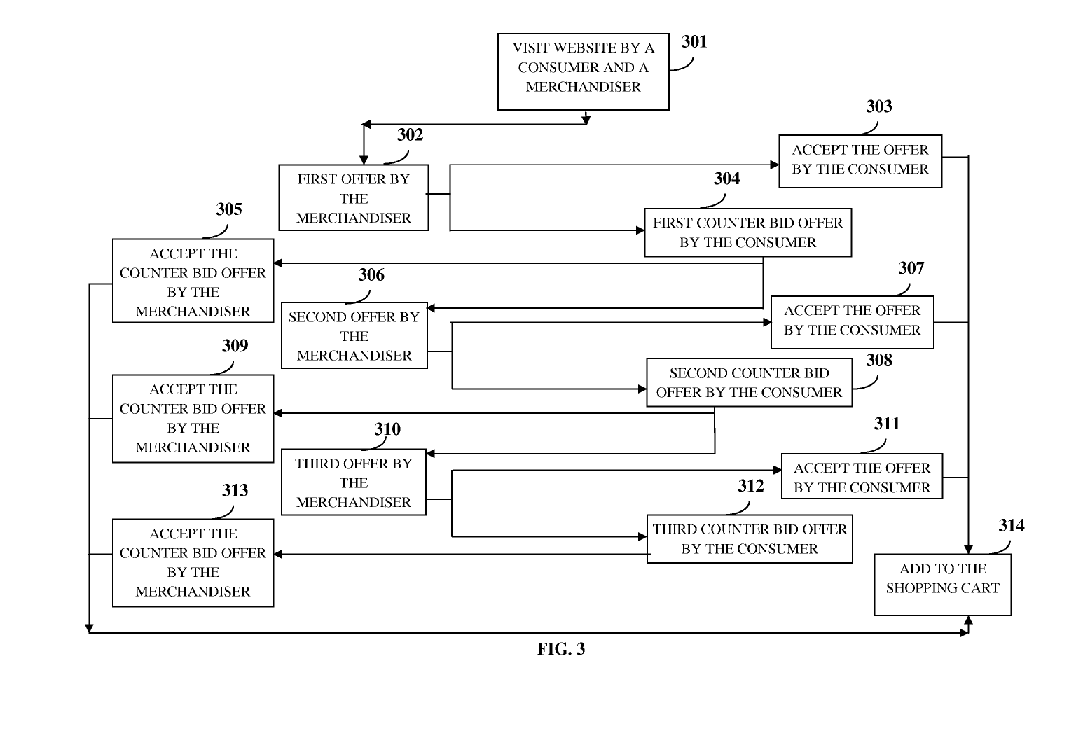

FIG. 3 exemplarily illustrates management of a fixed number of bargaining sessions by the sale management platform. The sale management platform determines the number of bargaining sessions, the time interval for each of the bargaining sessions, and the time interval for each sale. Consider an example where the sale management platform fixes the number of bargaining sessions at three for a particular time interval. A merchandiser and a consumer visit 301 the website hosted by the sale management platform at the optimal time interval determined by the sale management platform. The merchandiser makes a first offer 302 to the consumer. The consumer has the option to either accept the first offer or reject the first offer. If the consumer accepts 303 the first offer, the consumer can add 314 the sale item to a shopping cart provided on the website, purchase the sale item, and complete the sale. If the consumer rejects the first offer, the consumer makes a first counter bid offer 304 to the merchandiser. The merchandiser has the option to either accept or reject the first counter bid offer from the consumer. If the merchandiser accepts 305 the first counter bid offer, the consumer can add 314 the sale item to the shopping cart, purchase the sale item, and complete the sale. If the merchandiser rejects the first counter bid offer from the consumer, the merchandiser makes a second offer 306 to the consumer. The consumer has the option to either accept the offer or reject the second offer. If the consumer accepts 307 the second offer, the consumer can add 314 the sale item to the shopping cart, purchase the sale item, and complete the sale. If the consumer rejects the second offer, the consumer makes a second counter bid offer 308 to the merchandiser. The merchandiser again has the option to either accept or reject the second counter bid offer from the consumer. If the merchandiser accepts 309 the second counter bid offer, the consumer can add 314 the sale item to the shopping cart, purchase the sale item, and complete the sale. If the merchandiser rejects the second counter bid offer from the consumer, the merchandiser makes a third offer 310 to the consumer. The consumer has the option to either accept the third offer or reject the third offer. If the consumer accepts 311 the third offer, the consumer can add 314 the sale item to the shopping cart, purchase the sale item, and complete the sale. If the consumer rejects the third offer, the consumer makes a third counter bid offer 312 to the merchandiser. The merchandiser again has the option to either accept or reject the third counter bid offer from the consumer. If the merchandiser accepts 313 the third counter bid offer, the consumer can add 314 the sale item to the shopping cart, purchase the sale item, and complete the sale. If the merchandiser does not accept the consumer's counter bid offer, the sale management platform closes the sale after the third bargaining session.

In an embodiment, the sale management platform sends notifications to the merchandisers and the consumers. The sale management platform sends a notification or an alert to the merchandisers and the consumers with information on, for example, the sale based on preferences set by the consumers, the bargaining sessions, the quoted bid prices, the merchandiser-selected time interval, the consumer-selected time interval, the optimal time interval, a time interval triggered by a sale activity, the sale discount prices offered during the merchandiser-selected time interval, the consumer-selected time interval, or the optimal time interval, the quantity of the sale items that is placed on sale, information on a completed sale, etc. For example, the sale management platform sends a notification to the consumers and the merchandisers before initiation of the merchandiser-selected time interval and the consumer-selected time interval on the sale management platform via electronic communication, for example, via electronic mail (email), messages such as short message service (SMS) messages, multimedia messaging service (MMS) messages, etc.

The sale management platform also sends a notification to the consumers on the sale discount price offered during the consumer-selected time interval on the sale management platform via electronic communication, for example, via electronic mail (email), messages such as short message service (SMS) messages, multimedia messaging service (MMS) messages, etc. The sale management platform sends notifications or alerts to all the consumers and merchandisers engaged in the bargaining sessions and also notifies them if a sale is closed. The notifications comprise, for example, the time interval of the sale, the sale discount price, the highest bidder, the lowest seller, the status of the sale as open or closed, etc.

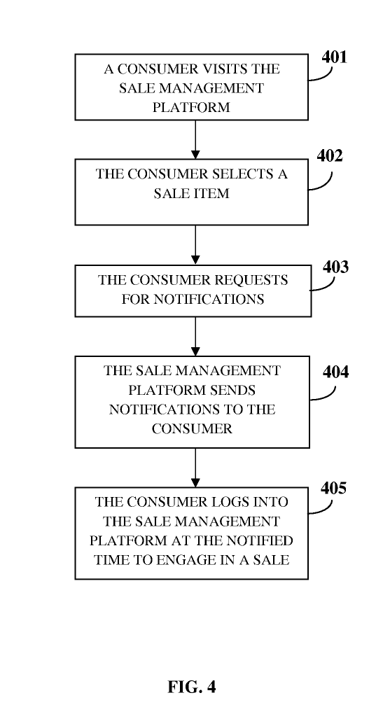

FIG. 4 exemplarily illustrates a computer implemented method for sending notifications about a time interval based sale of sale items to a consumer by the sale management platform. A consumer visits 401a website hosted by the sale management platform and selects 402 a sale item to purchase. The sale management platform provides an option for receiving notifications with information on the sale item to the consumer. The consumer can request 403 for notifications on the website. If the consumer chooses to be notified, the sale management platform sends 404 notifications regarding the sale of the selected sale item. In an example, the sale management platform sends notifications via electronic mail to the consumer's account held on the sale management platform. The notification sent by the sale management platform via electronic mail informs the consumer, for example, about the merchandiser-selected time interval or the optimal time interval and the sale discount price of the selected item. The consumer logs 405 into the sale management platform at the notified time to engage in a fixed price sale or a bargain sale with the merchandiser during the merchandiser-selected time interval or the optimal time interval. The sale management platform notifies the consumers of the sale discount prices of the sale items before initiation of the fixed price sale and/or the bargain sale to be held at the merchandiser-selected time interval, the consumer-selected time interval, or the optimal time interval.

In an embodiment, the sale management platform enables the consumers to set preferences for engaging in a sale and for indicating their interest in purchasing and/or bargaining for the sale items during the merchandiser-selected time interval, the consumer-selected time interval, or the optimal time interval. The sale management platform notifies the consumers of the time interval of the sale and the sale discount prices of the indicated sale items before initiation of the sale of the indicated sale items to be held at the time interval. For example, a consumer interested in purchasing a particular sale item can indicate the sale item as, for example, “interested to purchase in the time interval”, choose to be notified, add the sale item to a wish list, etc., on the sale management platform. The sale management platform then sends a notification of the sale discount price of the indicated sale item for the time interval to the consumer. In another example, a consumer interested in purchasing a particular sale item can indicate the sale item as, for example, “interested to purchase in my time interval” and then select the time interval on the sale management platform. The sale management platform sends a notification to one or more merchandisers who can then present a sale discount price for the sale item during the consumer-selected time interval. The consumers may also tag one or more sale items and merchandisers as favorites. In an embodiment, the sale management platform also sends notifications to the merchandisers about the preferences set by the consumers.

In an embodiment, the sale management platform tracks the purchases made by each of the consumers. Based on the tracking information and the preferences set by the consumer, for example, favorite sale items and favorite merchandisers, the sale management platform electronically notifies the consumer of the time interval during which the sale items are available for purchase at a discount on the sale management platform. The sale can be made to a group of consumers or to any consumer who has access to the sale management platform in the online environment.

In another example, a consumer interested in purchasing a particular sale item can indicate the sale item as, for example “interested to bargain in the time interval” on the sale management platform. The sale management platform then sends a notification of the time interval of the bargaining session to the consumer and the merchandisers. In another example, a consumer interested in purchasing a particular sale item can indicate the sale item as, for example, “interested to bargain in my time interval” and then select the time interval on the sale management platform. The sale management platform then sends a notification to one or more merchandisers to engage in a bargaining session with the consumer during the consumer-selected time interval.

The sale discount price can be lower or higher than the quoted prices in the previous bargaining session depending on the market. Consider an example where a merchandiser offers a television set at a sale discount price of $1000 and the consumer quotes a counter bid price of $500. The merchandiser makes another offer at $700 and the consumer makes another counter bid price offer at $550. The merchandiser is then allowed to make another offer at a higher price of $800. The time interval can vary for each sale, each bargain, and each sale item on sale.

In an embodiment, the sale management platform authenticates each of the merchandisers and provides each of the authenticated merchandisers with secure access to the sale management platform. The sale management platform requests the merchandisers to register with the sale management platform for engaging in a fixed price sale or a bargain sale with the consumers. The merchandisers register with the sale management platform via an interactive interface, for example, a webpage of a website hosted by the sale management platform. During registration, the merchandisers provide basic information, for example, name of the merchandiser, contact information such as mailing address, phone number, electronic mail (email) address, sale items that they intend to sell, awards, testimonials, etc. The merchandisers enter the basic information via a registration interface on the website hosted by the sale management platform.

The sale management platform then authenticates the information provided by the merchandisers and decides to accept or reject the merchandisers. In an example, the sale management platform authenticates merchandisers by cross checking the information provided by the merchandisers with reliable online databases. Once authenticated, the sale management platform registers the authenticated merchandisers on the sale management platform. Moreover, the sale management platform provides an authenticated merchandiser with a merchandiser account with secure access having a unique identifier name and password. The authenticated merchandisers can then log into their merchandiser account using the unique identifier name and password, upload the sale items that they intend to sell, and upload the sale discount prices of the sale items on the sale management platform. The merchandiser account also displays information relating to the merchandiser's sale items, for example, the number of consumers who showed interest in the merchandiser's sale items, sale items receiving maximum views from consumers, sale items most in demand, number of sale items sold, etc. The merchandisers are allowed to create a profile on the sale management platform. The sale management platform charges the merchandiser for the service that the sale management platform provides to the merchandiser.

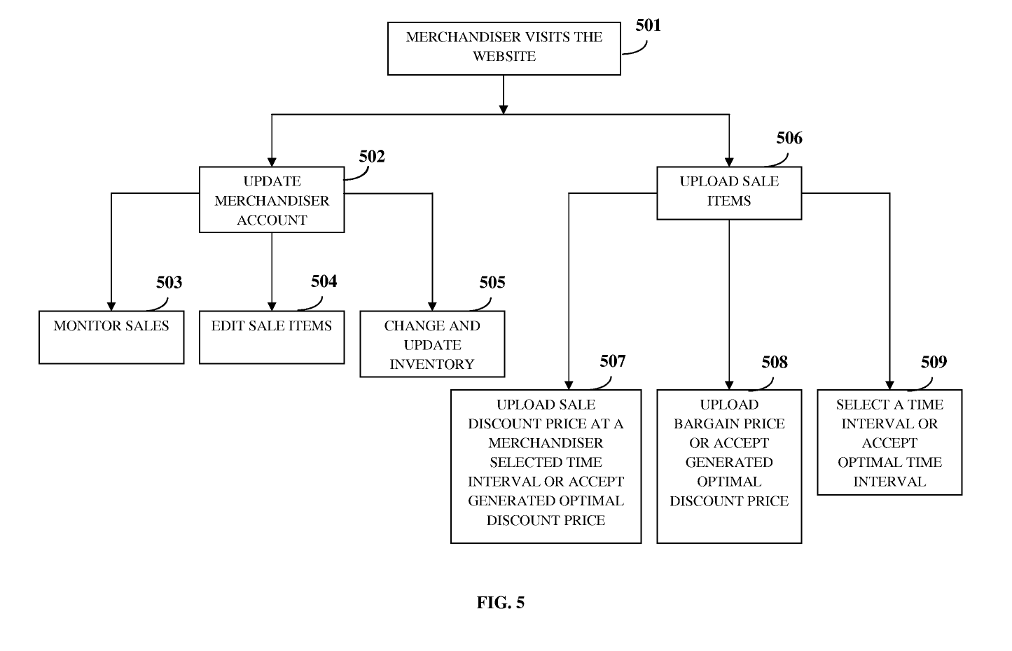

FIG. 5 exemplarily illustrates options presented to a merchandiser by the sale management platform. When a merchandiser visits 501 the website hosted by the sale management platform, the sale management platform provides options to update 502 the merchandiser account and upload 506 sale items. If the merchandiser chooses to update 502 the merchandiser account, the sale management platform allows the merchandiser to monitor 503 sales, edit 504 the sale items, or to change and update 505 the inventory of sale items. If the merchandiser chooses to upload 506 sale items, the sale management platform allows the merchandiser to upload 507 the sale discount price of each sale item for a merchandiser-selected time interval or accept the optimal discount price determined by the sale management platform, upload 508 the bargain price of each sale item for a bargaining session or accept the generated optimal discount price, or to select 509 a time interval or accept the optimal time interval determined by the sale management platform for a fixed price sale or a bargain sale.

The sale management platform enables merchandisers to monitor the sale of sale items, change the inventory, and edit and update the sale items. In an embodiment, the sale management platform charges a service fee to the merchandisers. Each of the merchandisers signs individual contracts for each sale item to be sold via the sale management platform. The contract may require the merchandiser to pay a commission to the sale management platform for each sale item sold on the sale management platform. The sale management platform also enables merchandisers to create a profile on the sale management platform. The merchandiser profiles can then be rated using the feedback on the merchandisers provided by the consumers.

The merchandiser along with a website administrator determines the time interval during which a particular sale item will be offered at discounted prices, the amount of discount, etc. The time interval may vary, for example, from a few minutes to a few hours or a few days and referred to as, for example, “online time interval” or “mega hour” or “online happy hour”. For example, air tickets for New York may be sold at a price of $500 compared to the original price of $650 only during 4.00 p.m. to 5.00 p.m. on a certain day. The sale management platform discloses the time interval price on the website minutes or hours before the mega hour begins. The sale management platform alerts the interested consumers electronically or by other means.

The sale management platform also determines the optimal time interval based on predetermined time criteria, for example, the sale discount prices offered by the merchandisers at different merchandiser-selected time intervals, the consumer-selected time intervals, sale activity of the sale items, etc. In an example, the sale management platform considers a weighted combination of the predetermined time criteria to compute the optimal time interval.

In another embodiment, the sale management platform selects the optimal time interval randomly from a list of time intervals stored in the database of the sale management platform. The list of time intervals comprises, for example, the consumer-selected time intervals, the merchandiser-selected time intervals, computed optimal time intervals selected based on the predetermined time criteria, etc. For example, when sale information of a sale item is uploaded on the sale management platform, the sale management platform randomly selects a time interval from the database which may have time intervals ranging from a few minutes to a few hours or a few days for a fixed price sale or a bargain sale.

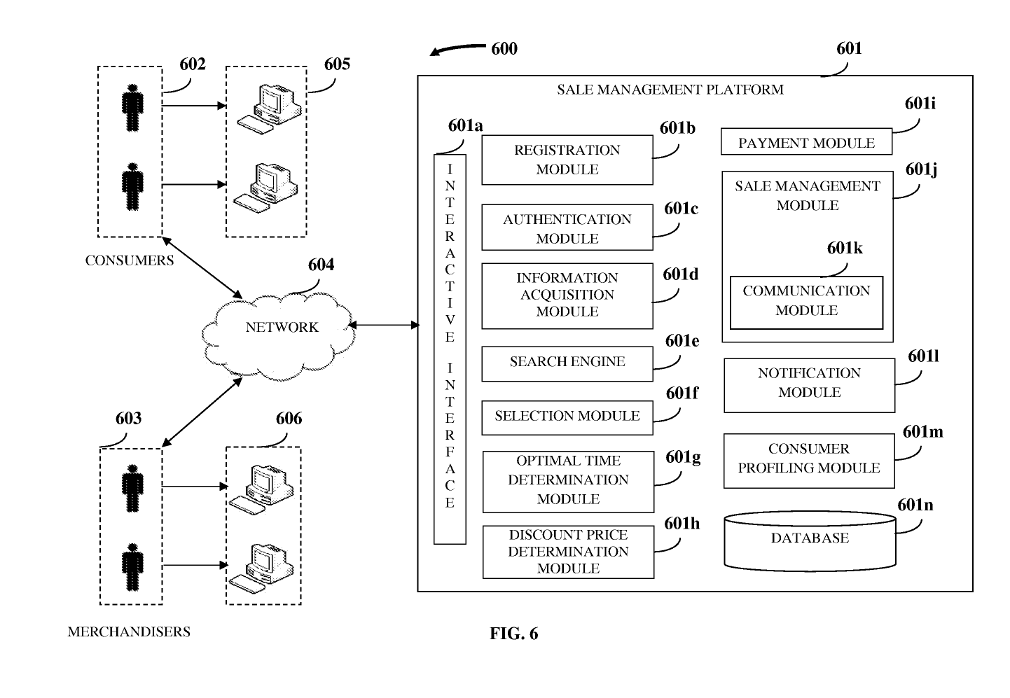

FIG. 6 illustrates a computer implemented system 600 for facilitating a time interval based sale of sale items in an online environment. The computer implemented system 600 disclosed herein comprises a sale management platform 601, for example, an online server, accessible by multiple consumers 602 and multiple merchandisers 603 in the online environment. The consumers 602 and merchandisers 603 access the sale management platform 601 through consumer devices 605 and merchandiser devices 606, respectively via a network 604, for example, the internet. The consumer devices 605 and the merchandiser devices 606 are, for example, computers, mobile phones, personal digital assistants, tablet computers, and other communication devices. The sale management platform 601 comprises an interactive interface 601a, a registration module 601b, an authentication module 601c, an information acquisition module 601d, a search engine 601e, a selection module 601f, an optimal time determination module 601g, a discount price determination module 601h, a payment module 601i, a sale management module 601j, a notification module 601l, a consumer profiling module 601m, and a database 601n.

The sale management platform 601 provides the interactive interface 601a to the consumers 602 and the merchandisers 603 to engage in a fixed price sale or a bargain sale having one or more bargaining sessions in the online environment. The interactive interface 601a is the front end of the sale management platform 601 which hosts the personal web pages and general web pages of the merchandisers 603 and the consumers 602 accessible via, for example, the world wide web. The interactive interface 601a, for example, is a webpage of a website hosted by the sale management platform 601. The modules, for example, 601b, 601c, 601d, 601e, 601f, 601g, 601h, 601i, 601j, 601k, 601l, and 601m of the sale management platform 601 form the back end of the sale management platform 601, which is accessible only to administrators or operators of the sale management platform 601.

The information acquisition module 601d acquires multiple sale items and sale information associated with each of the sale items from the merchandisers 603 via the interactive interface 601a. The information acquisition module 601d acquires sale information comprising, for example, merchandiser-selected time intervals, sale discount prices for the sale items during the merchandiser-selected time intervals, sale discount prices for the sale items during consumer-selected time intervals, etc. The information acquisition module 601d also acquires, for example, time intervals selected by the consumers 602 on the sale management platform 601. The search engine 601e enables the consumers 602 to search for sale items and the sale information on the sale management platform 601.

The registration module 601b registers the consumers 602 and the merchandisers 603 on the sale management platform 601 and creates consumer accounts and merchandiser accounts for the consumers 602 and the merchandisers 603 respectively. Moreover, the registration module 601b enables the consumers 602 to set preferences for engaging in a sale, for example, by enabling the consumers 602 to tag one or more sale items and one or more merchandisers 603 as favorites. Furthermore, the registration module 601b enables the consumers 602 to indicate an interest in purchasing and/or bargaining for the sale items during the merchandiser-selected time interval, the consumer-selected time interval, or an optimal time interval determined by the optimal time determination module 601g. The authentication module 601c authenticates the merchandisers 603 and provides the authenticated merchandisers 603 with secure access to the sale management platform 601 via the secure interactive interface 601a.

The selection module 601f selects one or more of the merchandisers 603 for engaging in a sale of one or more of the sale items selected by the consumers 602. In an embodiment, the selection module 601f selects one or more of the consumers 602 for engaging in a sale of one or more of the sale items with the selected merchandisers 603, for example, based on the consumer-selected time interval and bid prices offered by the consumers 602. The optimal time determination module 601g determines an optimal time interval for the sale of the selected sale items based on predetermined time criteria comprising, for example, the sale discount prices for the sale items, the consumer-selected time intervals, the merchandiser-selected time intervals, sale activity of the sale items such as past sales, demand for particular time intervals, a time interval selected by purchase behavior of the consumers 602, a search initiated by one or more of the consumers 602, purchase behavior of a unique group of consumers 602, etc.

The discount price determination module 601h determines optimal discount prices for the selected sale items based on one or more of the sale discount prices offered by each of the merchandisers 603, the acquired sale information, a fixed percentage decrease from a list price of each of the selected sale items, and predetermined price criteria comprising, for example, demand for the selected sale items, demand for the selected sale items during the merchandiser-selected time interval, the consumer-selected time interval, or the optimal time interval, mutually agreed conditions by the merchandisers 603 and the sale management platform 601, etc.

The payment module 601i requests the consumers 602 for payment information for charging the consumers 602 for the sale items on acceptance of an offer during the merchandiser-selected time interval, the consumer-selected time interval, or the optimal time interval. The payment module 601i enables the consumers 602 to transmit payment for a sale item on acceptance of an offer. The payment module 601i provides a payment interface, on which the consumers 602 enter the payment information. In an embodiment, the interactive interface 601a displays the payment interface comprising fields to capture electronic payment information of the consumers 602. The payment module 601i then transmits the payment information over a secure network from a consumer account to the merchandiser account via the sale management platform 601. In an example, the payment interface is associated with online payment processing services such as PayPal™ of eBay®. Inc., Authorize.Net® of Cybersource, etc.

The sale management module 601j manages a fixed price sale or a bargain sale of the selected sale items at one or more of the sale discount prices offered by the merchandisers 603 and the optimal discount prices during the merchandiser-selected time interval, the consumer-selected time interval, or the optimal time interval. The sale management module 601j conducts the bargain sale by managing multiple bargaining sessions between the merchandisers 603 and the consumers 602 during the merchandiser-selected time interval, the consumer-selected time interval, or the optimal time interval, on receiving a bargaining request from the consumers 602.

The sale management module 601j comprises a communication module 601k. The communication module 601k communicates one or more of the sale discount prices offered by the merchandisers 603 and the optimal discount prices for the selected sale items to the consumers 602. The communication module 601k also communicates one or more bid prices countering the sale discount prices and the optimal discount prices from the consumers 602 to the merchandisers 603 until the expiration of the merchandiser-selected time interval, the consumer-selected time interval, or the optimal time interval, or acceptance of an offer. The sale management module 601j determines number of bargaining sessions between the merchandisers 603 and the consumers 602, the time interval for each of the bargaining sessions, and a time interval for each sale. The communication module 601k communicates with the merchandisers 603 to determine the optimal time interval, the sale discount prices for the bargaining sessions, and the quantity of the sale items to be offered for the sale on the sale management platform 601.

The notification module 601l sends notifications to the merchandisers 603 and the consumers 602 with information on, for example, the merchandiser-selected time interval, the consumer-selected time interval, the optimal time interval, a time interval triggered by a sale activity, sale discount prices offered during the consumer-selected time interval, during the merchandiser-selected time interval, and during the optimal time interval, information of the sale based on preferences set by the consumers 602, information of a completed sale, etc.

The consumer profiling module 601m generates consumer profiles accessible by the merchandisers 603 for facilitating targeted advertising or for targeting particular consumers 602 with sale items and discount offers, for example, based on their purchasing patterns, preferred time intervals, preferred merchandisers 603, preferred sale items, etc. The sale management module 601j conducts a sale of targeted sale items at the merchandiser-selected time interval, the consumer-selected time interval, or the optimal time interval on the sale management platform 601. The database 601n stores the acquired sale information on the sale items, for example, discounts, information on the sale items in demand, preferences set by the consumers 602, information on the consumers 602 who showed interest in the sale items offered for sale by the merchandisers 603, the acquired sale information, and information on the fixed price sale, the bargain sale, the bargaining sessions, information on a period of the optimal time interval, etc. Moreover, the database 601n stores a list of the consumer-selected time intervals, the merchandiser-selected time intervals, and the determined optimal time intervals in a table. The number of time intervals in the table can vary from a few hundreds to a few thousands and range from a few minutes, to a few hours or a few days. The sale management platform 601 retrieves the information stored in the database 601n for display to the merchandisers 603.

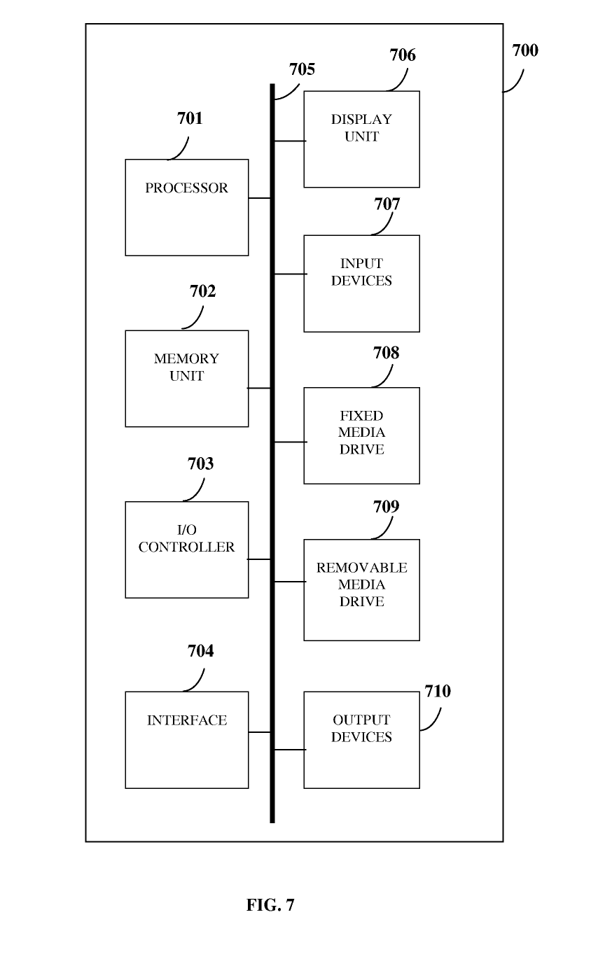

FIG. 7 exemplarily illustrates the architecture of a computer system 700 employed by the sale management platform 601 for facilitating a time interval based sale of sale items in an online environment. The computer system 700 comprises, for example, a processor 701, a memory unit 702 for storing programs and data, an input/output (I/O) controller 703, a network interface 704, a data bus 705, a display unit 706, input devices 707, a fixed media drive 708, a removable media drive 709, an output device 710, for example, a printer, etc.

The processor 701 is an electronic circuit that can execute computer programs. The memory unit 702 is used for storing programs, applications, and data. For example, the modules, for example, 601b, 601c, 601d, 601e, 601f, 601g, 601h, 601i, 601j, 601k, 601l, and 601m of the sale management platform 601 are stored on the memory unit 702 of the computer system 700. The memory unit 702 is, for example, a random access memory (RAM) or another type of dynamic storage device that stores information and instructions for execution by the processor 701. The memory unit 702 also stores temporary variables and other intermediate information used during execution of the instructions by the processor 701. The computer system 700 further comprises a read only memory (ROM) or another type of static storage device that stores static information and instructions for the processor 701.

The network interface 704 enables connection of the computer system 700 to the network 604. The network 604 is, for example, a local area network (LAN), a wide area network, a mobile communication network, etc. The computer system 700 communicates with other computer systems of, for example, the consumers 602, the merchandisers 603, etc., through the network interface 704. The network interface 704 comprises, for example, an infrared (IR) interface, a WiFi interface, a universal serial bus interface (USB), a local area network (LAN), a wide area network (WAN) interface, etc. The I/O controller 703 controls the input and output actions performed by administrators or operators of the sale management platform 601. The data bus 705 permits communication between the modules, for example, 601b, 601c, 601d, 601e, 601f, 601g, 601h, 601i, 601j, 601k, 601l, and 601m of the sale management platform 601.

The display unit 706 displays, via the interactive interface 601a, the actions computed by the sale management platform 601 to the consumers 602 and the merchandisers 603. The input devices 707 are used for inputting data into the computer system 700. The input devices 707 are, for example, a keyboard such as an alphanumeric keyboard, a joystick, a mouse, a touch pad, a light pen, etc.

The computer system 700 further comprises a fixed media drive 708 and a removable media drive 709 for receiving removable media. Computer applications and programs are used for operating the computer system 700. The programs are loaded onto the fixed media drive 708 and into the memory unit 702 of the computer system 700 via the removable media drive 709. In an embodiment, the computer applications and programs may be loaded directly via the network 604. Computer applications and programs are executed by double clicking a related icon displayed on the display unit 706 using one of the input devices 707. The consumers 602 and the merchandisers 603 interact with the computer system 700 of the sale management platform 601 using the interactive interface 601a.

The computer system 700 of the sale management platform 601 employs an operating system for performing multiple tasks. The operating system is responsible for management and coordination of activities and sharing of resources of the computer system 700. The operating system further manages security of the computer system 700, peripheral devices connected to the computer system 700, and network connections. The operating system recognizes keyboard inputs and pointing device inputs of an administrator, output display, files, and directories stored locally on the fixed media drive 708, for example, a hard drive. The operating system on the computer system 700 executes different programs, for example, a web browser, an electronic mail application, etc., initiated by an administrator using the processor 701. The processor 701 retrieves the instructions for executing the modules, for example, 601b, 601c, 601d, 601e, 601f, 601g, 601h, 601i, 601j, 601k, 601l, and 601m of the sale management platform 601 from the program memory in the form of signals. A program counter determines the location of the instructions in the program memory. The program counter stores a number that identifies the current position in the program of the modules, for example, 601b, 601c, 601d, 601e, 601f, 601g, 601h, 601i, 601j, 601k, 601l, and 601m of the sale management platform 601.

The instructions fetched by the processor 701 from the program memory after being processed are decoded. The instructions are placed in an instruction register in the processor 701. After processing and decoding, the processor 701 executes the instructions. For example, the information acquisition module 601d defines instructions for acquiring sale items and sale information via the interactive interface 601a. The registration module 601b defines instructions for registering the consumers 602 and the merchandisers 603 on the sale management platform 601. The authentication module 601c defines instructions for authenticating the merchandisers 603 and providing the authenticated merchandisers 603 with secure access to the sale management platform 601. The search engine 601e defines instructions for searching sale items and sale information on the sale management platform 601. The selection module 601f defines instructions for selecting one or more of the sale items, one or more of the consumers 602, one or more of the merchandisers 603, and an optimal time-interval for a sale. The optimal time determination module 601g defines instructions for determining the optimal time interval for the sale based on the predetermined time criteria. The discount price determination module 601h defines instructions for determining optimal discount prices for the selected sale items, for example, based on the predetermined price criteria. The sale management module 601j defines instructions for conducting and managing a fixed price sale or a bargain sale during the merchandiser-selected time interval, the consumer-selected time interval, or the optimal time interval. The sale management module 601j also defines instructions for managing multiple bargaining sessions between the merchandisers 603 and the consumers 602 during the merchandiser-selected time interval, the consumer-selected time interval, or the optimal time interval. The communication module 601k defines instructions for communicating the sale discount prices offered by the merchandisers 603 and the optimal discount prices for the selected sale items to the consumers 602 and for communicating the bid prices countering the sale discount prices and the optimal discount prices from the consumers 602 to the merchandisers 603 until expiration of the merchandiser-selected time interval, the consumer-selected time interval, or the optimal time interval, or acceptance of an offer. The payment module 601i defines instructions for requesting payment information from the consumers 602 and charging the consumers 602 using the payment information on acceptance of an offer. The notification module 601l defines instructions for electronically notifying the merchandisers 603 and the consumers 602 of, for example, the consumer-selected time interval, the merchandiser-selected time interval, the optimal time interval, a time interval triggered by a sale activity, sale discount prices offered during the consumer-selected time interval, during the merchandiser-selected time interval, and during the optimal time interval, information of the sale based on preferences set by the consumers 602, information of a completed sale, etc. The consumer profiling module 601m defines instructions for generating consumer profiles for facilitating targeted advertising by the merchandisers 603.

The processor 701 of the sale management platform 601 retrieves the instructions defined by the information acquisition module 601d, the registration module 601b, the authentication module 601c, the search engine 601e, the selection module 601f, the optimal time determination module 601g, the discount price determination module 601h, the sale management module 601j, the communication module 601k, the payment module 601i, the notification module 601l, and the consumer profiling module 601m, and executes the instructions.

At the time of execution, the instructions stored in the instruction register are examined to determine the operations to be performed. The processor 701 then performs the specified operations. The operations include arithmetic and logic operations. The operating system performs multiple routines for performing a number of tasks required to assign the input devices 707, output devices 710, and memory for execution of the modules, for example, 601b, 601c, 601d, 601e, 601f, 601g, 601h, 601i, 601j, 601k, 601l, 601m, etc., of the sale management platform 601. The tasks performed by the operating system comprise assigning memory to the modules, for example, 601b, 601c, 601d, 601e, 601f, 601g, 601h, 601i, 601j, 601k, 601l, 601m, etc., of the sale management platform 601, moving data between the memory unit 702 and disk units and handling input/output operations. The operating system performs the tasks on request by the operations and after performing the tasks, the operating system transfers the execution control back to the processor 701. The processor 701 continues the execution to obtain one or more outputs. The outputs of the execution of the modules, for example, 601b, 601c, 601d, 601e, 601f, 601g, 601h, 601i, 601j, 601k, 601l, 601m, etc., of the sale management platform 601 are displayed to the consumers 602 and the merchandisers 603 on the interactive interface 601a.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 701, except for a transitory, propagating signal.

The computer program product disclosed herein comprises multiple computer program codes for facilitating a time interval based sale of sale items in an online environment. For example, the computer program product disclosed herein comprises a first computer program code for acquiring multiple sale items and sale information associated with the sale items from the consumers 602 and the merchandisers 603, a second computer program code for selecting one or more of the consumers 602 and one or more of the merchandisers 603 for engaging in a sale, a third computer program code for determining an optimal time interval for the sale based on the predetermined time criteria, a fourth computer program code for determining optimal discount prices for the selected sale items, for example, based on the predetermined price criteria, a fifth computer program code for managing a fixed price sale or a bargain sale at one or more of the sale discount prices offered by the merchandisers 603 and the optimal discount prices during the merchandiser-selected time interval, the consumer-selected time interval, or the optimal time interval, a sixth computer program code for sending notifications to the merchandisers 603 and the consumers 602 with information on the merchandiser-selected time interval, the consumer-selected time interval, the optimal time interval, a time interval triggered by a sale activity, the sale discount prices offered during the consumer-selected time interval, during the merchandiser-selected time interval, and during the optimal time interval, information of the sale based on preferences set by the consumers 602, information of completed sale. The computer program product disclosed herein further comprises a seventh computer program code for triggering a time interval based sale of sale items, for example, based on demographic information of the consumers 602, a unique group of consumers 602, initiation of a search for the sale items by the consumers 602, group purchase of sale items, etc. The computer program product disclosed herein further comprises additional computer program codes for performing additional steps that may be required and contemplated for facilitating a time interval based sale of sale items in an online environment.

The computer program codes comprising the computer executable instructions for facilitating a time interval based sale of sale items in an online environment are embodied on the non-transitory computer readable storage medium. The processor 701 of the computer system 700 retrieves these computer executable instructions and executes them. When the computer executable instructions embodied on the non-transitory computer readable storage medium are executed by the processor 701, the computer executable instructions cause the processor 701 to perform the method steps for facilitating a time interval based sale of sale items in an online environment. In an embodiment, a single piece of computer program code comprising computer executable instructions performs one or more steps of the computer implemented method disclosed herein for facilitating a time interval based sale of sale items in an online environment.

For purposes of illustration, the detailed description refers to the sale management platform 601 being run locally on a computer system 700; however the scope of the computer implemented method and system 600 disclosed herein is not limited to the sale management platform 601 being run locally on the computer system 700 via the operating system and the processor 701, but may be extended to run remotely over the network 604 by employing a web browser and a remote server, a mobile phone, or other electronic devices.

The sale management platform 601 for facilitating a time interval based sale of discounted items to multiple consumers 602 in an online environment may also be implemented on operating systems for mobile devices, for example, Windows Mobile®, Symbian, Google™ Android, or Apple® iPhone. Mobile implementation uses similar algorithms but may involve different hardware interfaces. For example, the consumer 602 may select the sale item via a touch screen or via voice recognition. The sale management platform 601 may also be implemented on two different devices, for example, a desktop and a mobile device, to facilitate communication between them.

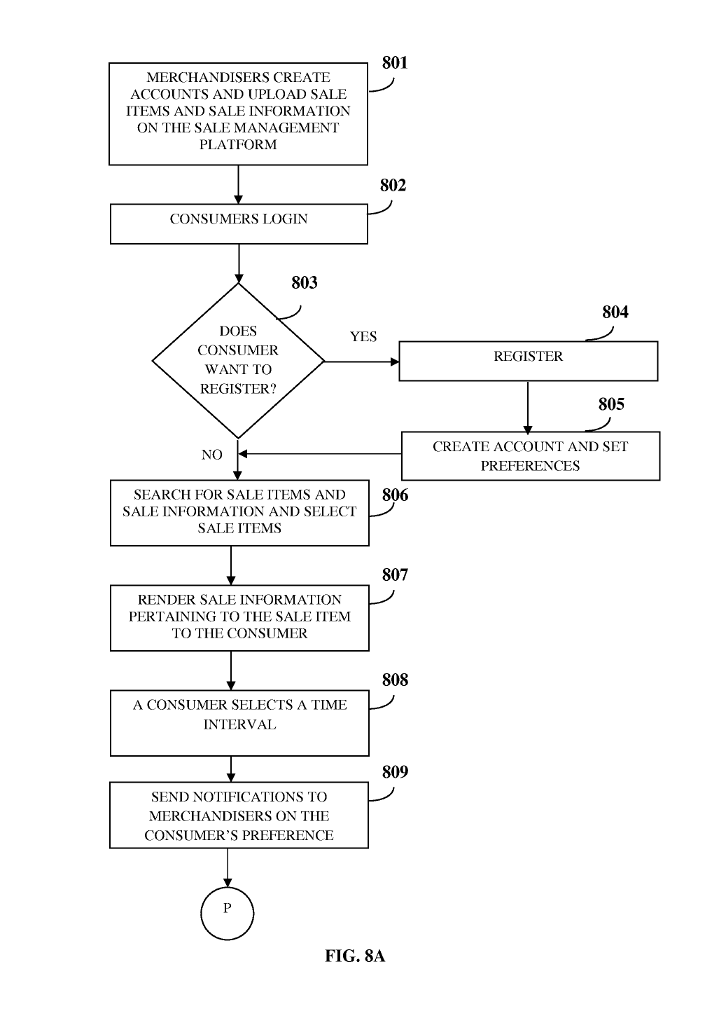

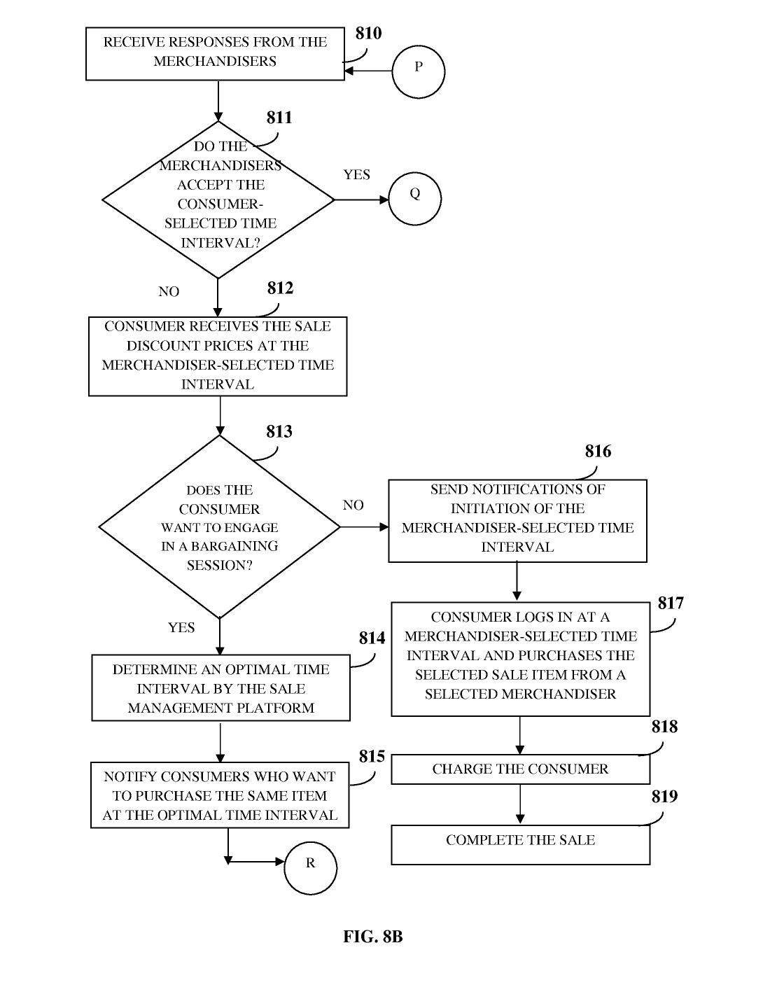

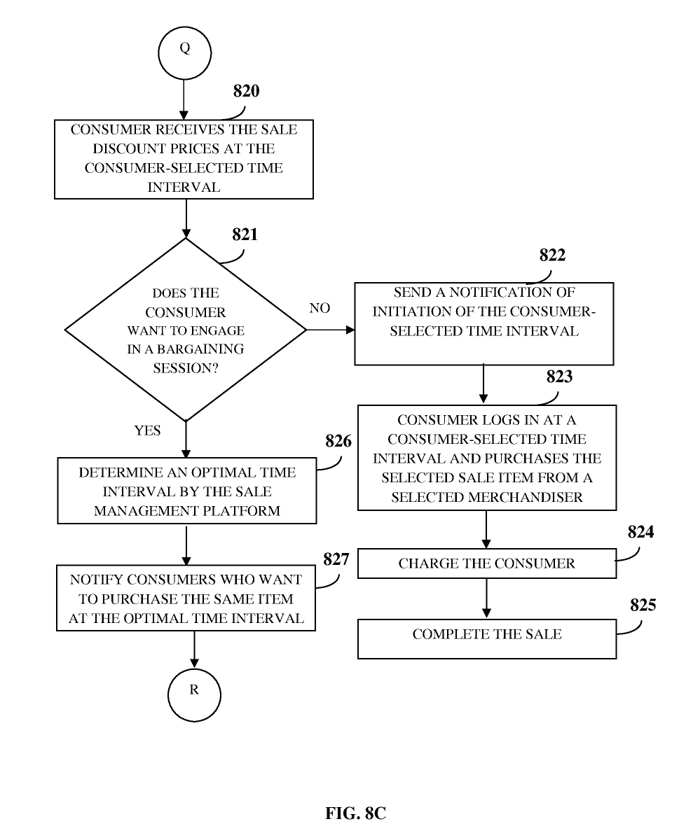

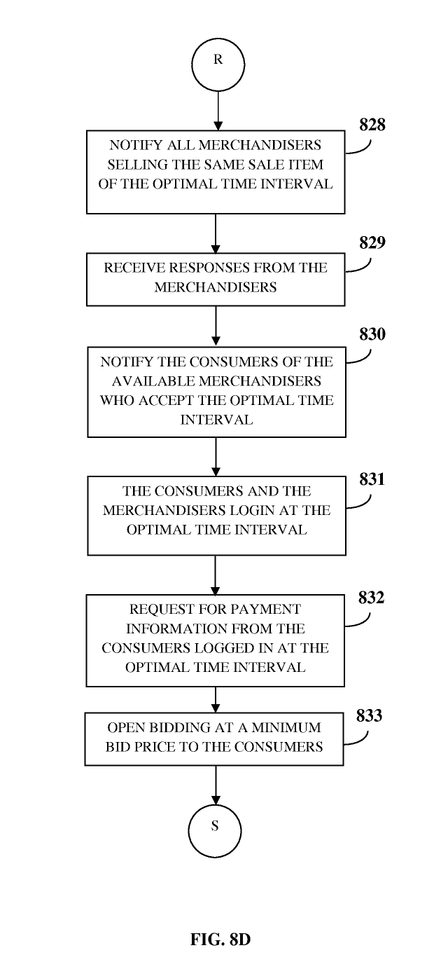

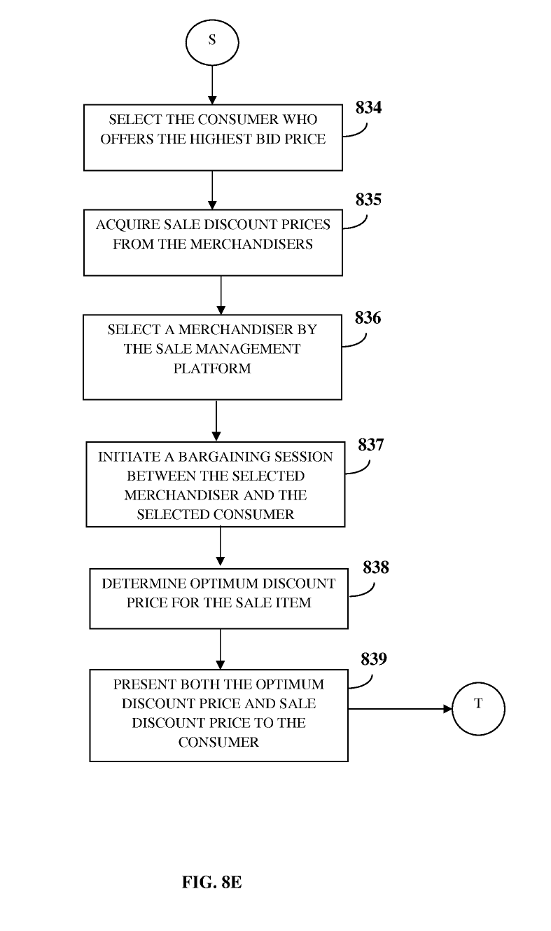

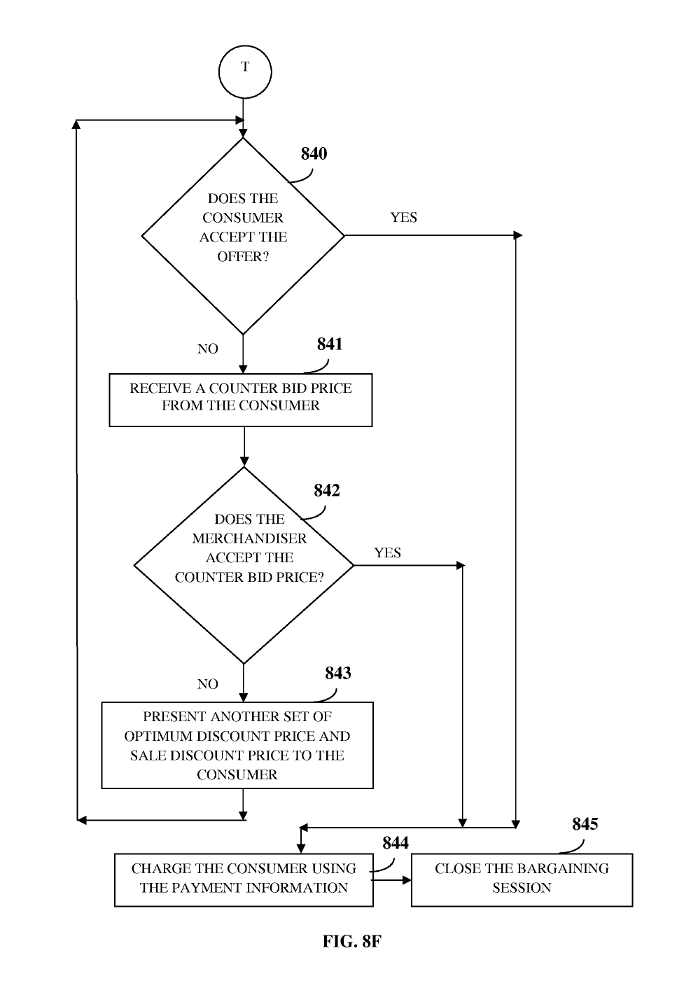

FIGS. 8A-8F exemplarily illustrate a flow chart comprising the steps for allowing consumers 602 to engage in a fixed price sale or a bargain sale in an online environment. Consider an example where the sale management platform 601 hosts a website for an online sale of items with a discounted price at a particular time interval when compared with the original price of the sale items. The merchandisers 603 who want to sell sale items, for example, travel tickets, consumer products, and other items, create 801 accounts with the sale management platform 601 by registering with the sale management platform 601. The merchandisers 603 may be required to pay a commission to the sale management platform 601 for each sale item sold on the sale management platform 601. On creation of the account, the merchandisers 603 upload 801 the sale items to be sold and sale information pertaining to each of the sale items on the sale management platform 601. The merchandisers 603 then create profiles that can be rated by the consumers' 602 feedback. The sale information comprises the description of the sale items, the selling price, and discounts offered on the sale items during a merchandiser-selected time interval. The time interval may vary, for example, from 15 minutes to a few hours or to a few days and is referred to as the online time interval, the mega hour, or the online happy hour. For example, air tickets for New York may be sold at price of $500 compared to the original price of $650 of the tickets only during 4.00 p.m. to 5.00 p.m. on a certain day. The sale management platform 601 discloses the time interval price on the web site minutes or hours before the time interval begins.

Consumers 602, who want to purchase the sale items, log 802 into the website hosted by the sale management platform 601. A registered or an unregistered consumer 602 may visit the website hosted by the sale management platform 601. The sale management platform 601 provides 803 an option to an unregistered consumer 602 to register on the sale management platform 601. If a consumer 602 wants to register, the sale management platform 601 registers 804 the consumer 602 and creates 805 an account for the consumer 602. On registration, the consumers 602 may set up profiles and configure settings and preferences associated with their account. The registered consumers 602 can, for example, request for alerts when sale items of their choice are offered at discounted prices, select a consumer-selected time interval, etc. The sale management platform 601 sends alerts to the consumers 602 when a time interval begins on the sale management platform 601. If the unregistered consumer 602 does not wish to register with the sale management platform 601, the unregistered consumer 602 can directly proceed to engage in a sale and purchase the sale items on the sale management platform 601.

The consumers 602 search 806 for the sale items they wish to purchase using the search engine 601e provided by the sale management platform 601. For example, if one of the consumers 602, namely, consumer P wants to purchase a 26 inch screen high definition television (HDTV), of Sony Electronics Inc., consumer P can conduct a search on the sale management platform 601 by entering—“26 inch”, “hdtv” and “sony” using the search engine 601e. The sale management platform 601 renders 807 sale information pertaining to the sale item, for example, a list of all merchandisers 603 offering the sale item for sale, profiles of each merchandiser 603, the sale discount prices, the time intervals for the discounts, etc., to consumer P. Consider an example where three merchandisers 603, namely, merchandiser A, merchandiser B, and merchandiser C may be selling the television set. Merchandiser A offers the television set for sale at a sale discount price of $1000 during the time interval 10 a.m. to 11 a.m. during weekdays and at a sale discount price of $1100 during the time interval 10 a.m. to 11 a.m. during the weekends. Merchandiser B offers the television set for sale at a sale discount price of $1100 during the time interval 10 a.m. to 12 p.m. during weekdays and at a sale discount price of $1100 during the time interval 10 a.m. to 12 p.m. during the weekends. Merchandiser C offers the television set for sale at a sale discount price of $900 during the time interval 2 p.m. to 4 p.m. during weekdays.

One of the consumers 602, namely, consumer P selects 808 the consumer-selected time interval for purchasing the sale item from merchandiser C as “10 a.m. to 11 a.m.”. The sale management platform 601 sends 809 notifications on the preferences of consumer P to merchandisers A, B and C. The sale management platform 601 receives 810 the responses from merchandisers A, B and C and electronically notifies consumer P of the decisions of merchandisers A, B and C. The sale management platform 601 checks 811 whether merchandisers A, B and C agree to the preferences, for example, the consumer-selected time interval, set by consumer P. If merchandisers A, B and C do not agree to the consumer-selected time interval, consumer P receives 812 the sale discount prices offered by merchandisers A, B and C at the merchandiser-selected time interval. The sale management platform 601 checks 813 whether consumer P wants to purchase the television set at the sale discount prices offered by merchandisers A, B and C or engage in a bargaining session with merchandisers A, B and C. If consumer P wants to engage in a bargaining session, the sale management platform 601 determines 814 an optimal time interval for engaging in the bargaining session. The sale management platform 601 notifies 815 all the consumers 602, including consumer P who want to engage in a bargaining session with merchandisers A, B and C for purchasing the same television set. If consumer P does not want to engage in a bargaining session, the sale management platform 601 sends 816 a notification to consumer P about the initiation of the sale at the merchandiser-selected time interval which is, for example, 2 p.m. to 4 p.m. Consumer P logs 817 into the website hosted by the sale management platform 601 during 2 p.m. to 4 p.m., and indicates that consumer P wishes to purchase the television set from merchandiser C. The sale management platform 601 requests consumer P for payment information prior to initiation of the sale, charges 818 consumer P $900 for the television set on receiving an indication of purchase, and completes 819 the sale.

If merchandisers A, B and C agree to the consumer-selected time interval set by consumer P, consumer P receives 820 the sale discount prices at the consumer-selected time-interval. The sale management platform 601 checks 821 whether consumer P wants to purchase the television set at the sale discount prices offered by merchandisers A, B and C or start a bargaining session with merchandisers A, B and C. If consumer P does not want to engage in a bargaining session, the sale management platform 601 sends 822 a notification to consumer P about the initiation of the sale at the consumer-selected time interval. Consumer P logs 823 into the website hosted by the sale management platform 601 during 10 a.m. to 11 a.m., and indicates that consumer P wishes to purchase the television set from merchandiser C. The sale management platform 601 requests consumer P for payment information prior to initiation of the sale, charges 824 consumer P $900 for the television set on receiving an indication of purchase, and completes 825 the sale. If consumer P wants to engage in a bargaining session, the sale management platform 601 determines 826 the optimal time interval as 1 p.m. to 2 p.m. for conducting the bargaining session. The sale management platform 601 notifies 827 all the consumers 602, for example, consumers P and Q who want to engage in the bargaining session with merchandisers A, B and C for purchasing the television set.

The sale management platform 601 electronically notifies 828 merchandisers A, B and C of the optimal time interval. The sale management platform 601 receives 829 responses from merchandisers A, B and C. Merchandisers A and B agree to the optimal time interval and electronically notify the sale management platform 601. The sale management platform 601 electronically notifies 830 consumers P and Q that merchandisers A and B are available for bargaining during the optimal time interval. The sale management platform 601 then conducts the bargaining session at the optimal time interval, that is, 1 p.m. to 2 p.m.

During the optimal time interval 1 p.m. to 2 p.m., consumers P and Q and merchandisers A and B log 831 into the website hosted by the sale management platform 601. The sale management platform 601 requests 832 payment information from consumers P and Q so that the selected consumer P or Q can be charged for the television set on acceptance of an offer. The sale management platform 601 opens 833 bidding at a minimum of $300 during the time interval 1 p.m. to 2 p.m., to consumers P and Q. Consumers P and Q offer bid prices of $300 and $350 respectively. The sale management platform 601 selects 834 consumer Q to engage in a bargaining session with merchandisers A and B.

The sale management platform 601 then acquires 835 the sale discount prices from merchandisers A and B. Merchandisers A and B offer sale discount prices of $900 and $1000 respectively. The sale management platform 601 selects 836 merchandiser A for online bargaining on the sale management platform 601, as merchandiser A offered the lowest sale discount price for the television set. The sale management platform 601 initiates 837 the bargaining session between consumer Q and merchandiser A during the optimal time interval 1 p.m. to 2 p.m.

The sale management platform 601 determines 838 an optimal discount price at $800 for the television set based on demand and a mutual agreement with merchandiser A. The sale management platform 601 presents 839 both the optimal discount price of $800 and the sale discount price of $900 to consumer Q. The sale management platform 601 checks 840 whether consumer Q accepts either offer. If consumer Q accepts either offer, the sale management platform 601 charges 844 consumer Q and closes 845 the bargaining session. If consumer Q does not accept the offer, the sale management platform 601 receives 841a counter bid price of $600 for the television set from consumer Q. The sale management platform 601 checks 842 whether merchandiser A accepts the counter bid price offer from consumer Q. If merchandiser A accepts the counter bid price offer, the sale management platform 601 charges 844 consumer Q and closes 845 the bargaining session. If merchandiser A does not accept the counter bid price offer, merchandiser A further makes a sale discount price offer of $850 and the sale management platform 601 determines the optimal discount price at $750. The sale management platform 601 then presents 843 prices $850 and $750 to consumer Q. Consumer Q has an option of offering counter bid prices till the expiration of the time interval 1 p.m. to 2 p.m. Consumer Q chooses to purchase the television set at $750. The sale management platform 601 charges 844 consumer Q to complete the sale and then closes 845 the bargaining session.

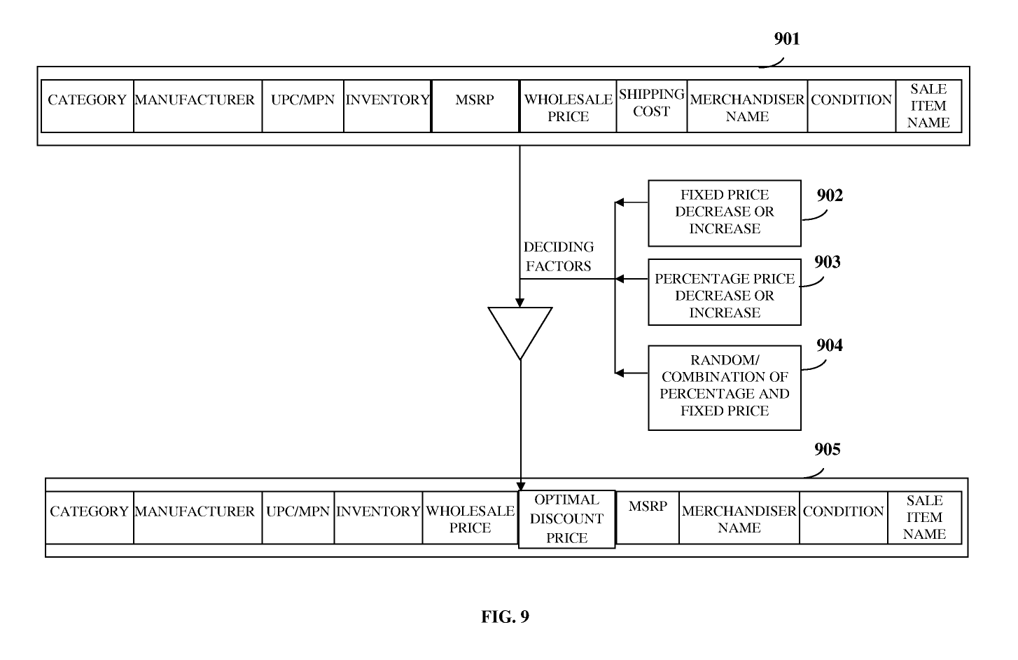

FIG. 9 exemplarily illustrates determination of an optimal discount price for a sale item based on multiple factors by the sale management platform 601. The sale management platform 601 receives merchandiser feed 901 from the merchandisers 603 who register with the sale management platform 601. The merchandiser feed 901 comprises, for example, the category of the sale item, the manufacturer of the sale item, the universal product code (UPC) or the manufacturer part number (MPN) of the sale item, the inventory, the manufacturer's suggested retail price (MSRP) of the sale item, the wholesale price of the sale item, the location, type, weight, and shipping cost of the sale item, the merchandiser's 603 name, the condition of the sale item, the name of the sale item, etc. The “category” of the sale item refers to a defined division in a system of classification of the sale items. In an example, the sale management platform 601 places laptops in the category of electronics. The “condition of the sale item” refers to whether the sale item is a used or a brand new sale item; and if the sale item is used, then the condition of the sale item includes the duration of use of the sale item.

The MSRP comprises, for example, the unit price, the retail price, the manufacturer price, the standard price, the tier 1 price, the tier 2 price, the tier 3 price, the distributor's price, and the suggested retail price (SRP). The standard price applies to quantities ranging from 1-50 sale items; the tier 1 price applies to quantities ranging from 51-100 sale items; the tier 2 price applies to quantities ranging from 101-1000 sale items; and the tier 3 price applies to quantities greater than 1000 sale items. The wholesale prices comprises, for example, the wholesale price, the dealer price, the dealer net price, the truckload (TL) pricing, published price to dealer (PPD) pricing, and the minimum advertized (MA) price.

In an embodiment, the sale management platform 601 determines the optimal discount price for the sale item based on a fixed price decrease or increase 902 from the MSRP or the wholesale price of the sale item. The sale management platform 601 determines the optimal discount price by deducting, for example, the fixed price decrease amount 902 from the MSRP. The resultant price is the optimal discount price that the sale management platform 601 presents to the consumers 602, for example, during the optimal time interval. The sale management platform 601 computes the fixed price decrease or increase 902 based on the demand for the sale item during the optimal time interval, number of consumers 602 available during the optimal time interval, the number of merchandisers 603 available during the optimal time interval, etc. Consider an example where the MSRP of a sale item as offered by the merchandiser 603 is $100 and a fixed price decrease 902, as computed by the sale management platform 601 is $20. Therefore, the optimal discount price for the sale item during the optimal time interval is MSRP-fixed price decrease 902, that is $100−$20=$80.

In another embodiment, the sale management platform 601 determines the optimal discount price for the sale item based on a percentage price decrease or increase 903 from the MSRP or the wholesale price. For example, the sale management platform 601 determines the optimal discount price by computing the price decrease from the percentage price decrease 903 and deducting the price decrease from the MSRP or the wholesale price of the sale item. The sale management platform 601 then presents the computed price as the optimal discount price to the consumer 602, for example, during the optimal time interval. The sale management platform 601 computes the percentage price decrease or increase 903 based on the demand for the sale item during the optimal time interval, number of consumers 602 available during the optimal time interval, the number of merchandisers 603 available during the optimal time interval, etc. In an example, the MSRP of a sale item as offered by a merchandiser 603 is $100 and the percentage price decrease 903, as computed by the sale management platform 601 is 30%. Therefore, the price decrease is 30% of 100 that is $30; and the optimal discount price for the sale item during the optimal time interval is MSRP-price decrease, that is, $100−$30=$70.

In another embodiment, the sale management platform 601 determines the optimal discount price for the sale item based on a combination price decrease 904. The combination price decrease 904 comprises the fixed price decrease 902 or a random price decrease and the percentage price decrease 903. The sale management platform 601 determines the random price decrease by varying any amount of the fixed price decrease 902 and the percentage price decrease 903. The optimal discount price is different for different consumers 602. The sale management platform 601 computes an intermediate price by first computing the price decrease from the percentage price decrease 903 and adding the price decrease from the percentage price decrease 903 to the fixed price decrease 902. The sale management platform 601 then deducts the intermediate price from the MSRP of the sale item to arrive at the optimal discount price.

In an example, the MSRP as offered by the merchandiser 603 is $100 and the combination price decrease 904 is 20% of MSRP+$20. Therefore, the optimal discount price is the MSRP—the combination price decrease 904. The combination price decrease 904 is 20% of 100+$20=$40; and the optimal discount price is $100−($20+$20)=100−40=$60. The combination price decrease 904 is computed by varying any amount of the fixed price decrease 902 and the percentage price decrease 903. The output feed 905 is therefore computed by the sale management platform 601 based on the deciding factors, for example, the fixed price decrease 902, the percentage price decrease 903, and a random or combination 904 of percentage price decrease 903 and fixed price decrease 902.

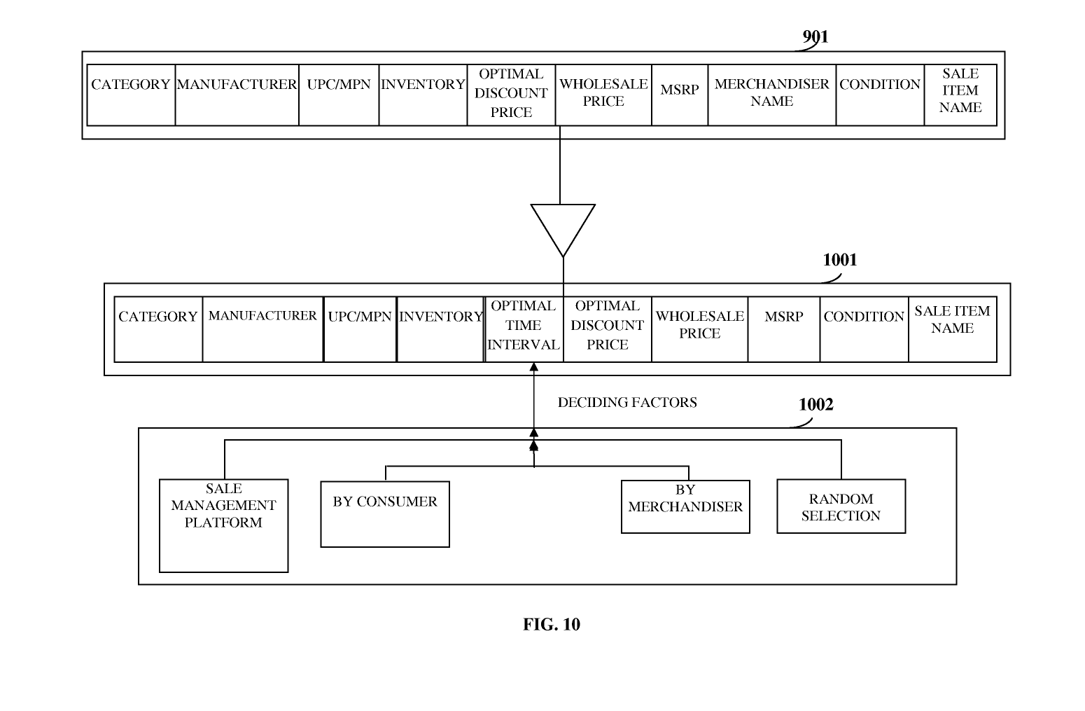

FIG. 10 exemplarily illustrates determination of an optimal time interval for a fixed price sale or a bargain sale based on multiple factors 1002 by the sale management platform 601. The sale management platform 601 receives merchandiser feed 901 from the merchandisers 603 who register with the sale management platform 601 as disclosed in the detailed description of FIG. 9. In an embodiment, the sale management platform 601 determines an optimal time interval for conducting a fixed price sale or a bargain sale. The sale management platform 601 determines the optimal time interval based on the predetermined time criteria comprising, for example, the sale discount prices for the sale items, the consumer-selected time intervals, the merchandiser-selected time intervals, sale activity of the sale items, a time interval selected by the sale management platform 601, a time interval selected by purchase behavior of the consumers 602, a search initiated by one or more of the consumers 602, purchase behavior of a unique group of consumers 602, consumer purchasing activity, etc. The sale activity of the sale items comprises, for example, number of searches for the sale item, time of the search, demand for the sale item, etc. The consumer purchasing activity comprises, for example, preceding consumer online activities, etc.

In an embodiment, the sale management platform 601 selects the consumer-selected time interval as the optimal time interval for the fixed price sale or the bargain sale. The sale management platform 601 enables consumers 602 to select their preferred time interval for engaging in the fixed price sale or the bargain sale. The sale management platform 601 informs the merchandisers 603 about the consumer-selected time interval by sending notifications to the merchandisers 603. If the merchandisers 603 agree to the consumer-selected time interval, the sale management platform 601 conducts the fixed price sale or the bargain sale during the consumer-selected time interval.

In another embodiment, the sale management platform 601 selects the merchandiser-selected time interval as the optimal time interval for the fixed price sale or the bargain sale. The sale management platform 601 enables the merchandisers 603 to provide their preferred time interval for engaging in the fixed price sale or the bargain sale. The sale management platform 601 informs the consumers 602 about the merchandiser-selected time interval by sending notifications to the consumers 602. If the consumers 602 agree to the merchandiser-selected time interval, the sale management platform 601 conducts the fixed price sale or the bargain sale during the merchandiser-selected time interval.

In another embodiment, the sale management platform 601 determines the optimal time interval for the fixed price sale or the bargain sale based on random selection. The optimal time determination module 601g of the sale management platform 601 generates random time intervals during which the sale management platform 601 conducts the fixed price sale or the bargain sale. The time intervals generated by random selection may vary from a few minutes to a few hours or a few days. The output feed 1001 is therefore computed by the sale management platform 601 based on factors 1002, for example, selections made by the sale management platform 601, the consumer 602, the merchandiser 603, or by a random selection received from a consumer 602, a merchandiser 603, the sale management platform 601 or a combination thereof. The output feed 1001 is also computed, for example, based on a search performed by the consumer 602, number of purchases of the same sale item by defined consumers 602, notifications, etc.

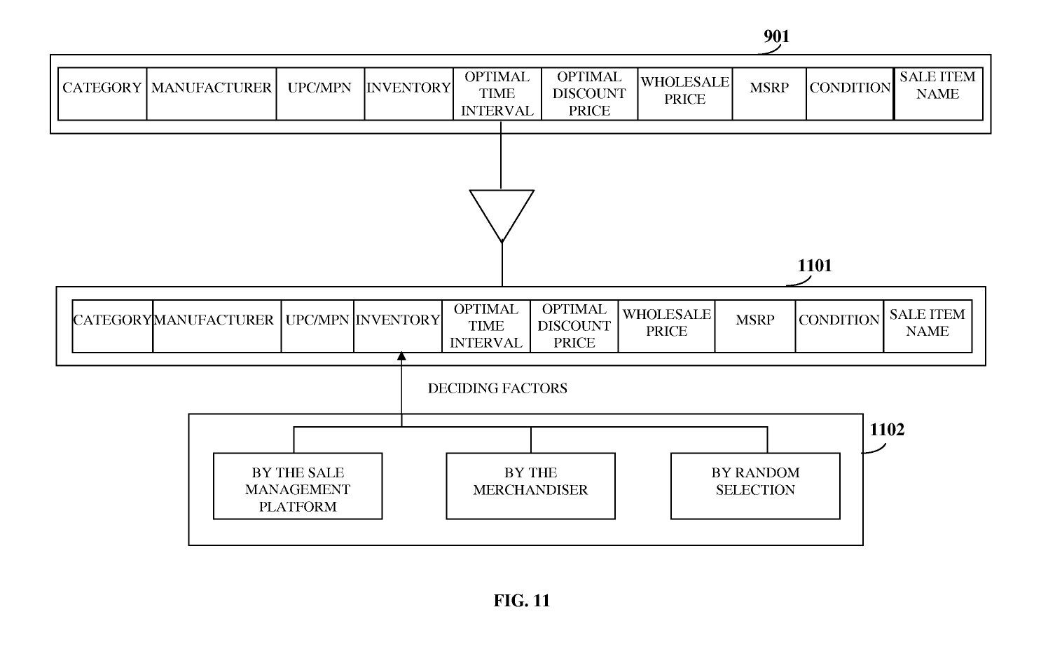

FIG. 11 exemplarily illustrates determination of quantity of sale items to be offered for sale by the sale management platform 601. The sale management platform 601 receives merchandiser feed 901 from the merchandisers 603 who register with the sale management platform 601 as disclosed in the detailed description of FIG. 9. The inventory for the time interval sale is selected from, for example, about 1% to about 100% of the available inventory. In an embodiment, the sale management platform 601 determines the sales inventory based on a fixed selection, a percentage based selection, or a random selection. In the fixed selection, the sale management platform 601 determines a fixed quantity of sale items for sale that is lesser than the total available inventory provided by the merchandisers 603. In the percentage based selection, the sale management platform 601 determines the percentage of the sale items to be offered for sale. In the random selection, the sale management platform 601 determines a random quantity of the sale items to be offered in the sale.

In an embodiment, the sale management platform 601 enables the merchandisers 603 to select the quantity of sale items to be offered for sale during a particular time interval. The merchandiser 603 determines the sales inventory based on factors 1102, for example, the fixed selection, the percentage based selection, or the random selection. In another embodiment, the sale management platform 601 determines the quantity of sale items to be offered for sale based on factors 1102 associated with the selection of the sale management platform 601 and the merchandisers 603. The output feed 1101 is therefore computed by the sale management platform 601 based factors 1102, for example, selections made by the sale management platform 601, the merchandiser 603, or by a random selection 1102.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the database 601n, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communication means or combination of communication means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for facilitating a time interval based sale of sale items in an online environment, comprising:
providing a sale management platform to a plurality of consumers and a plurality of merchandisers in said online environment;
acquiring a plurality of said sale items and sale information associated with said sale items from said merchandisers and said consumers by said sale management platform, wherein said sale information comprises a time interval for said sale of said sale items at sale discount prices offered by each of said merchandisers, a time interval selected by each of said consumers, sale discount prices for said sale items during a merchandiser-selected time interval, and sale discount prices for said sale items during a consumer-selected time interval;
selecting one or more of said merchandisers by said sale management platform for engaging in a sale of one or more of said sale items selected by said consumers;
determining an optimal time interval for said sale of said selected one or more sale items based on predetermined time criteria by said sale management platform;
determining optimal discount prices for said selected one or more sale items based on said sale discount prices offered by each of said selected one or more merchandisers, said acquired sale information, a fixed percentage of a list price of each of said selected one or more sale items, and predetermined price criteria by said sale management platform; and
managing said sale of said selected one or more sale items at one or more of said sale discount prices offered by said selected one or more merchandisers and said optimal discount prices during one of said merchandiser-selected time interval, said consumer-selected time interval, and said optimal time interval, wherein said sale of said selected one or more sale items is one of a fixed price sale and a bargain sale;
whereby said sale management platform facilitates said time interval based sale of said sale items in said online environment.

2. The computer implemented method of claim 1, wherein said sale management platform conducts said bargain sale by managing a plurality of bargaining sessions between said selected one or more merchandisers and said consumers during said one of said merchandiser-selected time interval, said consumer-selected time interval, and said optimal time interval, on receiving a bargaining request from said consumers, wherein said management of said bargaining sessions comprises:
communicating one or more of said sale discount prices offered by said selected one or more merchandisers and said optimal discount prices for said selected one or more sale items to said consumers; and
communicating one or more bid prices countering said sale discount prices and said optimal discount prices from said consumers to said selected one or more merchandisers until one of expiration of said one of said merchandiser-selected time interval, said consumer-selected time interval, and said optimal time interval, and acceptance of an offer.

3. The computer implemented method of claim 2, further comprising determining number of said bargaining sessions between said selected one or more merchandisers and said consumers, a time interval for each of said bargaining sessions, and a time interval for each said sale by said sale management platform.

4. The computer implemented method of claim 1, further comprising selecting one or more of said consumers for engaging in said sale of one or more of said sale items with said selected one or more merchandisers by said sale management platform based on said consumer-selected time interval and bid prices offered by said consumers.

5. The computer implemented method of claim 1, further comprising requesting said consumers for payment information by said sale management platform, wherein said sale management platform charges said consumers for said selected one or more sale items using said payment information on acceptance of said offer during said one of said merchandiser-selected time interval, said consumer-selected time interval, and said optimal time interval.

6. The computer implemented method of claim 1, wherein said predetermined time criteria for determining said optimal time interval for said sale of said selected one or more sale items by said sale management platform comprise one or more of said sale discount prices for said sale items, said consumer-selected time interval, said merchandiser-selected time interval, sale activity of said sale items, a time interval selected by said sale management platform, a time interval selected by purchase behavior of said consumers, a search initiated by one or more of said consumers, and purchase behavior of a unique group of consumers.

7. The computer implemented method of claim 1, wherein said predetermined price criteria for determining said optimal discount prices for said selected one or more sale items by said sale management platform comprise one or more of demand for said selected one or more sale items, demand for said selected one or more sale items during one of said merchandiser-selected time interval, said consumer-selected time interval, and said optimal time interval, and mutually agreed conditions by said merchandisers and said sale management platform.

8. The computer implemented method of claim 1, further comprising enabling said consumers to set preferences for engaging in said sale and for indicating an interest in purchasing and/or bargaining for said sale items during one of said merchandiser-selected time interval, said consumer-selected time interval, and said optimal time interval by said sale management platform, wherein said setting of said preferences comprises tagging one or more of said sale items and one or more of said merchandisers as favorites by said consumers.

9. The computer implemented method of claim 1, wherein said sale management platform selects one or more of said merchandisers to engage in said sale based on said sale discount prices, said consumer-selected time interval, preferences set by said consumers, reputation of said merchandisers, value-added services offered by said merchandisers, and quality of said sale items offered for said sale by said merchandisers.

10. The computer implemented method of claim 1, further comprising registering said consumers and said merchandisers on said sale management platform and creating consumer accounts and merchandiser accounts respectively.

11. The computer implemented method of claim 1, further comprising sending notifications to said merchandisers and said consumers with information on said merchandiser-selected time interval, said consumer-selected time interval, said optimal time interval, a time interval triggered by a sale activity, said sale discount prices offered during said consumer-selected time interval, during said merchandiser-selected time interval, and during said optimal time interval, information of said sale based on preferences set by said consumers, and information of a completed sale by said sale management platform.

12. The computer implemented method of claim 1, further comprising storing information on said sale items in demand, preferences set by said consumers, and said consumers who showed interest in said sale items offered for said sale by said merchandisers in a database and retrieving said information for display to said merchandisers by said sale management platform.

13. The computer implemented method of claim 1, further comprising computing discounts on maximum selling price of each of said sale items by said sale management platform, wherein said sale management platform offers said sale items at said computed discounts for said sale at one of said merchandiser-selected time interval, said consumer-selected time interval, and said optimal time interval.

14. The computer implemented method of claim 1, further comprising authenticating said merchandisers by said sale management platform and providing each of said authenticated merchandisers with secure access to said sale management platform.

15. The computer implemented method of claim 1, further comprising notifying said consumers of said sale discount prices of said selected one or more sale items by said sale management platform before initiation of one or more of said fixed price sale and said bargain sale to be held at said one of said merchandiser-selected time interval, said consumer-selected time interval, and said optimal time interval.

16. The computer implemented method of claim 1, further comprising generating consumer profiles accessible by said merchandisers by said sale management platform for facilitating targeted advertising by said merchandisers, and conducting a sale of targeted sale items at one of said merchandiser-selected time interval, said consumer-selected time interval, and said optimal time interval by said sale management platform.

17. The computer implemented method of claim 1, wherein said sale management platform, in communication with said merchandisers, determines quantity of said sale items to be offered for said sale during said consumer-selected time interval, said merchandiser-selected time interval, and said optimal time interval, and determines a period of said optimal time interval for each said sale.

18. The computer implemented method of claim 1, wherein said sale management platform triggers said time interval based sale of said sale items based on demographic information of said consumers, a unique group of consumers, initiation of a search for said sale items by said consumers, and group purchase of said sale items.

19. A computer implemented system for facilitating a time interval based sale of sale items in an online environment, comprising:
a sale management platform accessible by a plurality of consumers and a plurality of merchandisers in said online environment, wherein said sale management platform comprises:
an information acquisition module that acquires a plurality of said sale items and sale information associated with said sale items from said merchandisers and said consumers via an interactive interface, wherein said sale information comprises a time interval for said sale of said sale items at sale discount process offered by each of said merchandisers, a time interval selected by each of said consumers, sale discount prices for said sale items during a merchandiser-selected time interval, and sale discount prices for said sale items during a consumer-selected time interval;
a selection module that selects one or more of said merchandisers for engaging in a sale of one or more of said sale items selected by said consumers;
an optimal time determination module that determines an optimal time interval for said sale of said selected one or more sale items based on predetermined time criteria, wherein said predetermined time criteria comprise one or more of said sale discount prices for said sale items, said consumer-selected time interval, said merchandiser-selected time interval, sale activity of said sale items, a time interval selected by said sale management platform, a time interval selected by purchase behavior of said consumers, a search initiated by one or more of said consumers, and purchase behavior of a unique group of consumers;
a discount price determination module that determines optimal discount prices for said selected one or more sale items based on one or more of said sale discount prices offered by each of said selected one or more merchandisers, said acquired sale information, a fixed percentage of a list price of each of said selected one or more sale items, and predetermined price criteria; and
a sale management module that manages said sale of said selected one or more sale items at one or more of said sale discount prices offered by said selected one or more merchandisers and said optimal discount prices during one of said merchandiser-selected time interval, said consumer-selected time interval, and said optimal time interval, wherein said sale of said selected one or more sale items is one of a fixed price sale and a bargain sale;
whereby said sale management platform facilitates said time interval based sale of said sale items in said online environment.

20. The computer implemented system of claim 19, wherein said sale management module conducts said bargain sale by managing a plurality of bargaining sessions between said selected one or more merchandisers and said consumers during said one of said merchandiser-selected time interval, said consumer-selected time interval, and said optimal time interval, on receiving a bargaining request from said consumers, wherein said sale management module comprises a communication module that communicates one or more of said sale discount prices offered by said selected one or more merchandisers and said optimal discount prices for said selected one or more sale items to said consumers, and that communicates one or more bid prices countering said sale discount prices and said optimal discount prices from said consumers to said selected one or more merchandisers until one of expiration of said one of said merchandiser-selected time interval, said consumer-selected time interval, and said optimal time interval, and acceptance of an offer.

21. The computer implemented system of claim 19, wherein said sale management platform further comprises a payment module that requests said consumers for payment information, wherein said payment module charges said consumers for said selected one or more sale items using said payment information on acceptance of said offer during said one of said merchandiser-selected time interval, said consumer-selected time interval, and said optimal time interval.

22. The computer implemented system of claim 19, wherein said sale management platform further comprises a registration module that registers said consumers and said merchandisers on said sale management platform and creates consumer accounts and merchandiser accounts respectively, wherein said registration module enables said consumers to set preferences for engaging in said sale and for indicating an interest in purchasing and/or bargaining for said sale items during one of said merchandiser-selected time interval, said consumer-selected time interval, and said optimal time interval.

23. The computer implemented system of claim 19, wherein said sale management platform further comprises an authentication module that authenticates said merchandisers and provides said authenticated merchandisers with secure access to said sale management platform.

24. The computer implemented system of claim 19, wherein said sale management platform further comprises a search engine that enables said consumers to search for said sale items and said sale information on said sale management platform.

25. The computer implemented system of claim 19, wherein said sale management platform further comprises a notification module that sends notifications to said merchandisers and said consumers with information on said merchandiser-selected time interval, said consumer-selected time interval, said optimal time interval, a time interval triggered by a sale activity, said sale discount prices offered during said consumer-selected time interval, during said merchandiser-selected time interval, and during said optimal time interval, information of said sale based on preferences set by said consumers, and information of a completed sale.

26. The computer implemented system of claim 19, wherein said sale management platform further comprises a database that stores information on said sale items in demand, preferences set by said consumers, said consumers who showed interest in said sale items offered for said sale by said merchandisers, said acquired sale information, and information on a period of said optimal time interval, said fixed price sale, and said bargain sale.

27. A computer program product comprising computer executable instructions embodied in a non-transitory computer readable storage medium, wherein said computer program product comprises:
a first computer program code for acquiring a plurality of sale items and sale information associated with said sale items from a plurality of merchandisers and a plurality of consumers by a sale management platform, wherein said sale information comprises a time interval for a sale of said sale items at sale discount prices offered by each of said merchandisers, a time interval selected by each of said consumers, sale discount prices for said sale items during a merchandiser-selected time interval, and sale discount prices for said sale items during a consumer-selected time interval;
a second computer program code for selecting one or more of said merchandisers for engaging in a sale of one or more of said sale items selected by said consumers;
a third computer program code for determining an optimal time interval for said sale of said selected one or more sale items based on predetermined time criteria, wherein said predetermined time criteria comprise one or more of said sale discount prices for said sale items, said consumer-selected time interval, said merchandiser-selected time interval, sale activity of said sale items, a time interval selected by said sale management platform, a time interval selected by purchase behavior of said consumers, a search initiated by one or more of said consumers, and purchase behavior of a unique group of consumers;
a fourth computer program code for determining optimal discount prices for said selected one or more sale items based on said sale discount prices offered by each of said selected one or more merchandisers, said acquired sale information, a fixed percentage of a list price of each of said selected one or more sale items, and predetermined price criteria by said sale management platform, wherein said predetermined price criteria comprise one or more of demand for said selected one or more sale items, demand for said selected one or more sale items during one of said merchandiser-selected time interval, said consumer-selected time interval, said optimal time interval, and mutually agreed conditions by said merchandisers and said sale management platform;
a fifth computer program code for managing said sale of said selected one or more sale items at one or more of said sale discount prices offered by said selected one or more merchandisers and said optimal discount prices during one of said merchandiser-selected time interval, said consumer-selected time interval, and said optimal time interval, wherein said sale of said selected one or more sale items is one of a fixed price sale and a bargain sale; and
a sixth computer program code for sending notifications to said merchandisers and said consumers with information on said merchandiser-selected time interval, said consumer-selected time interval, said optimal time interval, a time interval triggered by a sale activity, said sale discount prices offered during said consumer-selected time interval, during said merchandiser-selected time interval, and during said optimal time interval, information of said sale based on preferences set by said consumers, and information of a completed sale.

28. The computer program product of claim 27, further comprising a seventh computer program code for triggering a time interval based sale of said sale items based on demographic information of said consumers, a unique group of consumers, initiation of a search for said sale items by said consumers, and group purchase of sale items.
